(19) United States
(12) Patent Application Publication
(10) Pub. No.: US 2019/0332334 A1
(43) Pub. Date: Oct. 31, 2019

(54) IMAGE PROCESSING APPARATUS, CONTROL METHOD THEREFOR, AND STORAGE MEDIUM STORING PROGRAM

(71) Applicant: CANON KABUSHIKI KAISHA, Tokyo (JP)

(72) Inventors: Toshio Yoshihara, Kawasaki-shi (JP); Yoshihisa Nomura, Kashiwa-shi (JP); Shigeki Hasui, Tokyo (JP); Masanori Ichikawa, Tokyo (JP)

(21) Appl. No.: 16/392,175

(22) Filed: Apr. 23, 2019

(30) Foreign Application Priority Data
Apr. 26, 2018 (JP) 2018-085615

(51) Int. Cl. G06F 3/12; H04W 4/80; H04M 1/725; H04N 1/00

(52) U.S. Cl. CPC G06F 3/1204; G06F 3/1259; G06F 3/1226; G06F 3/1231; G06F 3/1292; G06F 3/121; H04M 1/7253; H04N 1/00411; G06F 3/1286; H04W 4/80

(57) ABSTRACT

An image processing apparatus includes a wireless communication interface that wirelessly communicates with a mobile terminal, an element that initiates wireless communication with the mobile terminal, a light emitting element, associated with the element, that emits light, and at least one controller that causes the light emitting element to emit light in response to occurrence of an event requiring communication with the mobile terminal.

### BACKGROUND

### Field

The present disclosure relates to an image processing apparatus, a control method therefor, and a storage medium storing a program. The image processing apparatus is used, for example, as an office machine such as a scanner and a printer, and a home appliance.

### Description of the Related Art

Conventionally, an image processing apparatus such as a printer can receive a user's operation on a panel, which includes buttons and the like, provided to the image processing apparatus. In addition, a printer that receives an operation for cooperating with a mobile terminal such as a smartphone has become widespread. Japanese Patent Application Laid-Open No. 2017-85236 discusses a technique for connecting a printer and a mobile terminal via a wireless local area network (LAN) in response to a touch operation performed on the mobile terminal as a trigger, and exchanging print jobs via the wireless LAN using near field communication (NFC). The printer displays information about the cooperation on a display of the printer so that a user can understand a timing for establishing the cooperation with the mobile terminal.

A printer, such as a home-use small printer, is known that does not have a display from viewpoints of space saving and cost reduction. This type of printer can alternatively have a display that is used for notifying users of only limited information. In view of diverse users, it is desirable that various functions also be available in such a printer with lower operability features. In particular, it is desirable that a function of cooperation with a mobile terminal be available. In such case, it is also desirable that an operation for the cooperation between the mobile terminal and the printer be performed easily even without display of information on a screen.

### SUMMARY

The present disclosure is directed to an image processing apparatus that can provide excellent operability without depending on display of information on a screen.

The present disclosure is also directed to an image processing apparatus that can prompt a user to perform an operation for cooperation with a mobile terminal without depending on the display of information on the screen.

According to an aspect of the present disclosure, an image processing apparatus includes a wireless communication interface configured to wirelessly communicate with a mobile terminal, an element configured to initiate wireless communication with the mobile terminal, a light emitting element, associated with the element, configured to emit light, and at least one controller configured to cause the light emitting element to emit light in response to occurrence of an event requiring communication with the mobile terminal.

Further features will become apparent from the following description of exemplary embodiments with reference to the attached drawings.

### BRIEF DESCRIPTION OF THE DRAWINGS

FIG. 1 is a block diagram illustrating an example of a system configuration of an image processing system.

FIGS. 2A and 2B are block diagrams each illustrating an example of a hardware configuration of a multifunction peripheral (MFP).

FIG. 3 is a diagram illustrating an example of a panel configuration of an operation unit.

FIG. 4 is a block diagram illustrating an example of a hardware configuration of a mobile terminal.

FIGS. 5A and 5B are flowcharts illustrating an example of basic information processing according to a first exemplary embodiment.

FIG. 6 is a diagram illustrating an example of an administrator setting screen.

FIG. 7 is a flowchart illustrating an example of copy processing.

FIG. 8 is a flowchart illustrating an example of cancel processing.

FIG. 9 is a flowchart illustrating an example of scan processing.

FIG. 10 is a flowchart illustrating an example of post scan processing.

FIG. 11 is a flowchart illustrating an example of processing based on a mobile operation.

FIG. 12 is a flowchart illustrating an example of information processing by the mobile terminal.

FIGS. 13A, 13B, 13C, and 13D are diagrams each illustrating a display screen example of the mobile terminal.

FIG. 14 is a diagram illustrating an example of a screen in performing the stop processing.

FIGS. 15A and 15B are flowcharts illustrating an example of basic information processing according to a second exemplary embodiment.

FIG. 16 is a diagram illustrating another example of an administrator setting screen.

FIG. 17 is a diagram illustrating another example of a panel configuration of an operation unit.

FIG. 18 is a diagram illustrating an example of button information.

FIGS. 19A and 19B are diagrams each illustrating an example of an operation screen of a printer driver.

FIG. 20 is a flowchart illustrating an example of information processing performed by a personal computer (PC).

FIG. 21 is a diagram illustrating an example of a password input screen.

FIG. 22 is a flowchart illustrating an example of information processing for secure print output.

### DESCRIPTION OF THE EMBODIMENTS

Exemplary embodiments will be described with reference to the drawings.

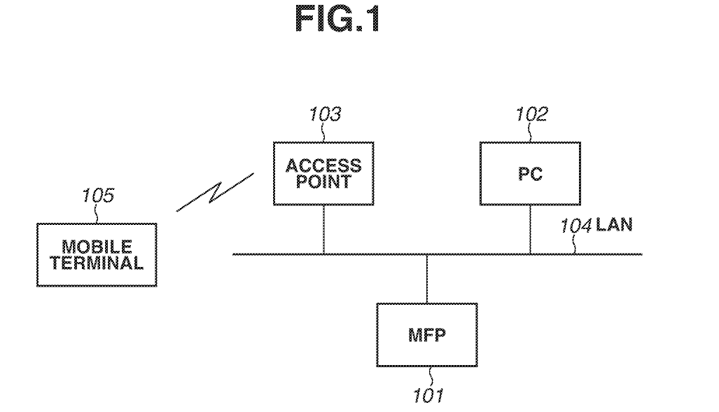

FIG. 1 is a diagram illustrating an example of a system configuration of an image processing system. A multifunction peripheral (MFP) 101 communicates with another apparatus on a local area network (LAN) 104. A personal computer (PC) 102 communicates with the MFP 101 via the LAN 104. The PC 102 can be connected to the LAN 104 by a physical cable or can be connected to the LAN 104 via an access point 103 by wirelessly communicating with the access point 103. The access point 103 interconnects the LAN 104 and the PC 102 in wireless communication. The wireless communication may also be performed based on Wireless Fidelity (Wi-Fi®) such as IEEE 802.11a/b/g/n/ac or Bluetooth®. The LAN 104 enables communication by interconnecting the MFP 101, the PC 102, and the access point 103. It is common to use Ethernet® for a physical layer and a link layer. A mobile terminal 105 communicates with the MFP 101 by connecting to the LAN 104 via the access point 103. Application software for cooperation with the MFP 101 is installed in the mobile terminal 105. The mobile terminal 105 performs setting for various kinds of operations such as a scan operation and a copy operation based on the application software. The mobile terminal 105 can perform an operation in cooperation with the MFP 101 based on the setting.

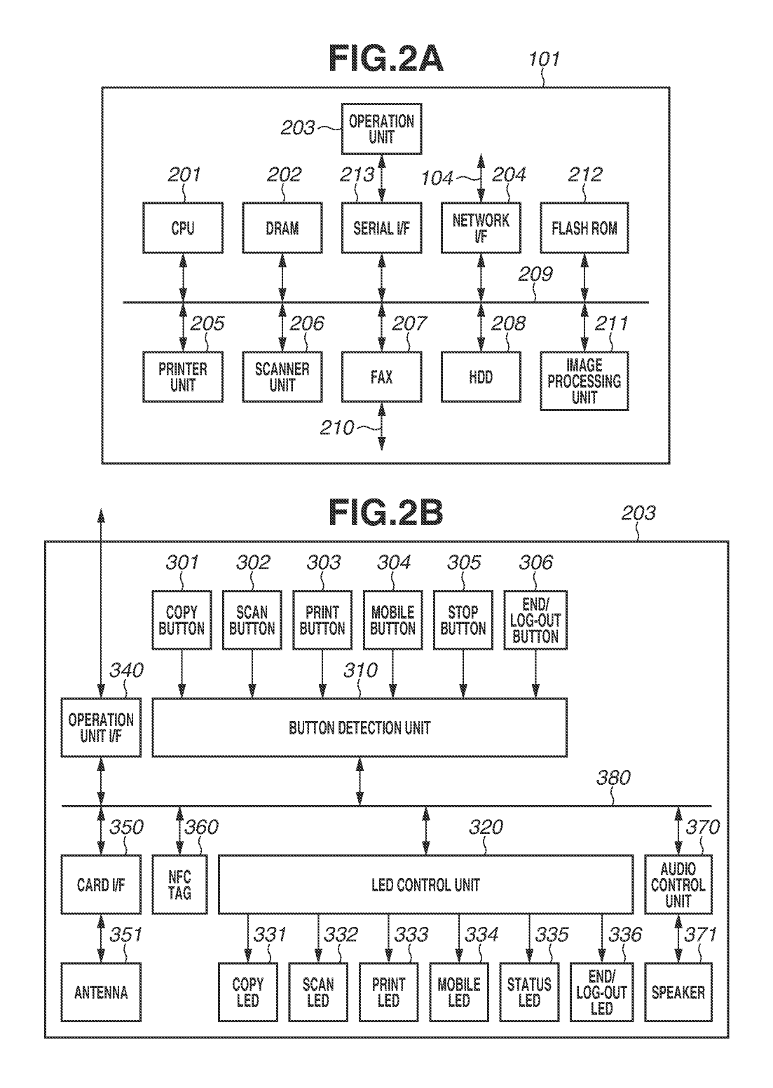

FIG. 2A is a block diagram illustrating an example of a hardware configuration of the MFP 101. A central processing unit (CPU) 201 controls the entire MFP 101. A dynamic random access memory (DRAM) 202 stores a program to be executed by the CPU 201 and functions as a work area for temporary data. An operation unit 203 notifies the CPU 201 of an operation by a user via a serial interface (I/F) 213. A network I/F 204 performs communication with an external apparatus by connecting to the LAN 104. A printer unit 205 prints image data on a sheet surface. A scanner unit 206 generates a scanned image by optically reading an image on a sheet surface and converting the image into an electrical signal. A fax 207 performs facsimile communication with an external apparatus by connecting to a public line 210. A hard disk drive (HDD) 208 stores a program to be executed by the CPU 201 and is used as a spool area for jobs such as a print job and a scan job. A signal bus 209 performs communication by interconnecting modules. The public line 210 interconnects the fax 207 and the external apparatus. An image processing unit 211 executes processing such as processing of converting a print job received by the network I/F 204 into an image suitable for printing by the printer unit 205, and processing such as noise removal, color space conversion, rotation, and compression of a scanned image obtained by the scanner unit 206. A flash read only memory (ROM) 212 stores a program to be executed by the CPU 201. The flash ROM 212 also stores values such as a default setting value for the MFP 101, a default setting value for each user, and a temporary custom setting value (hereinafter referred to as “default setting values”). The serial I/F 213 interconnects the operation unit 203 and the signal bus 209.

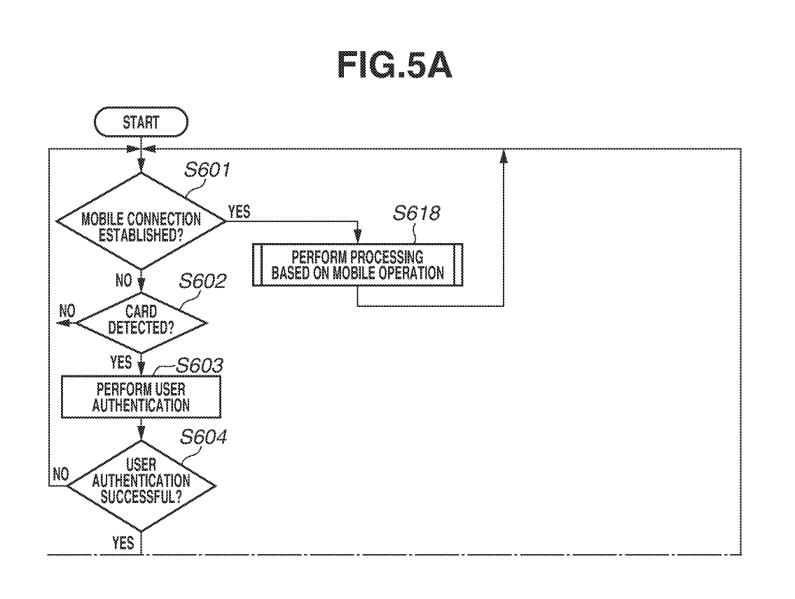

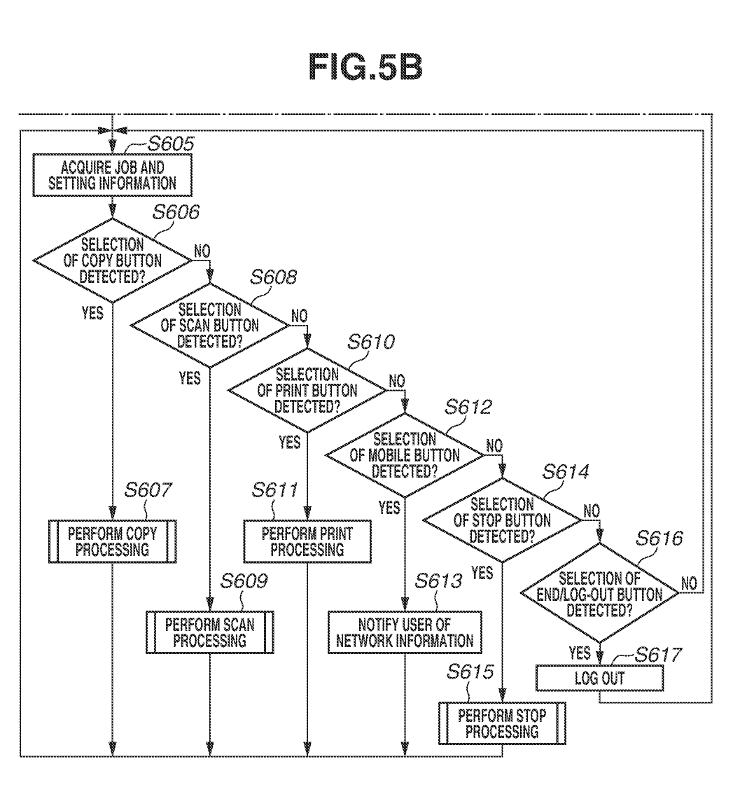

The CPU 201 performs processing based on the program stored in the flash ROM 212, so that a function of the MFP 101 and processing of flowcharts in FIGS. 5A and 5B, 7 to 11, 15A and 15B, and 22 described below are implemented.

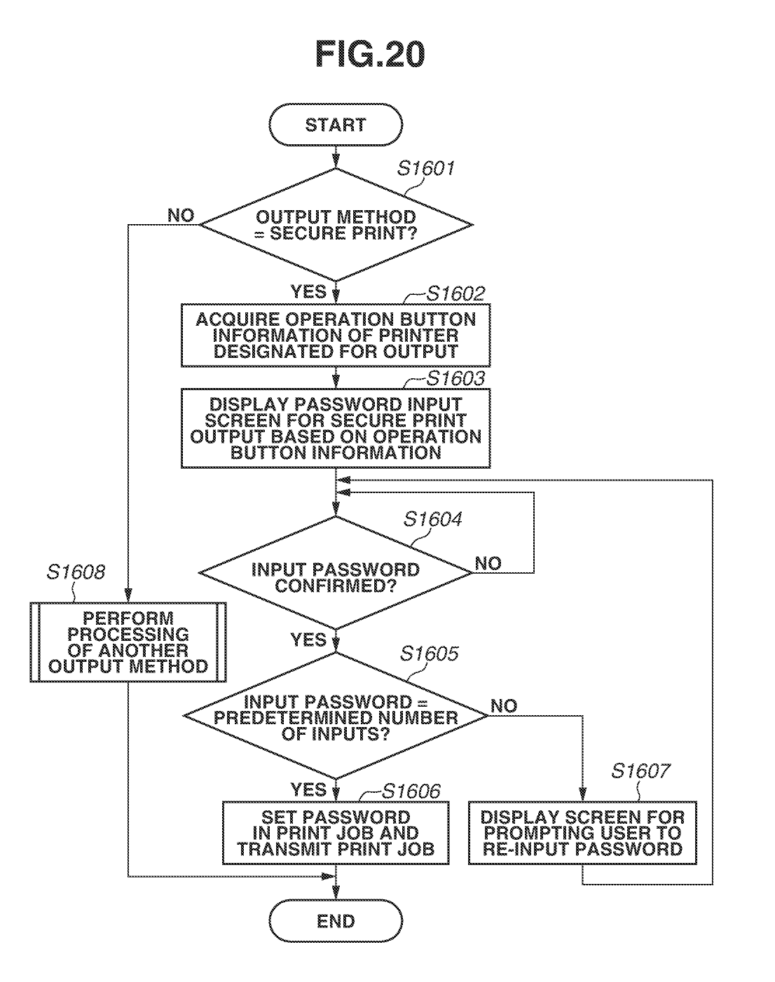

The PC 102 also includes a CPU and a memory as part of a hardware configuration. The CPU of the PC 102 executes processing based on a program stored in the memory of the PC 102, so that functions of the PC 102 and processing of the flowchart in FIG. 20 described below are implemented.

FIG. 2B is a block diagram illustrating an example of a hardware configuration of the operation unit 203 that is not provided with a liquid crystal display (LCD) that displays abundant information. If a copy button 301 is selected (pressed) by the user, a button detection unit 310 detects a press of the copy button 301. If a scan button 302 is selected by the user, the button detection unit 310 detects a press of the scan button 302. If a print button 303 is selected by the user, the button detection unit 310 detects a press of the print button 303. If a mobile button 304 is selected by the user, the button detection unit 310 detects a press of the mobile button 304. If a stop button 305 is selected by the user, the button detection unit 310 detects a press of the stop button 305. If an end/log-out button 306 is selected by the user, the button detection unit 310 detects the end/log-out button 306. The button detection unit 310 detects an on/off status of each of the buttons, and notifies the CPU 201 of the detected status via an operation unit I/F 340 and the serial I/F 213. A copy light emitting diode (LED) 331 is controlled by the CPU 201 to be turned on via an LED control unit 320. A scan LED 332 is controlled by the CPU 201 to be turned on via the LED control unit 320. A print LED 333 is controlled by the CPU 201 to be turned on via the LED control unit 320. A mobile LED 334 is controlled by the CPU 201 to be turned on via the LED control unit 320. A status LED 335 is controlled by the CPU 201 to be turned on via the LED control unit 320. An end/log-out LED 336 is controlled by the CPU 201 to be turned on via the LED control unit 320. The operation unit IF 340 transfers a signal to each of the control units of the operation unit 203 by receiving a control command from the CPU 201 via the serial I/F 213.

If a card I/F 350 detects that a contactless card is held over an antenna 351, the card I/F 350 notifies the CPU 201 of this detection by an interrupt. In addition, the card I/F 350 reads information of the contactless card and writes the read information in the DRAM 202. The antenna 351 is electromagnetically coupled with the contactless card to perform wireless communication. The contactless card performs communication through, for example, near field communication (NFC). In the first exemplary embodiment, the card IF 350 is used in a reader/writer mode in which the information of the contactless card can be read. The information included in the contactless card includes a unique identification (ID) number that is recorded at the time of manufacturing the card and that cannot be rewritten. The card I/F 350 may notify the CPU 201 of the unique ID number of this card to refer to information about a user who owns this card, in a database stored in the HDD 208. The information include an identification number, an e-mail address, and a favorite setting for each operation of the user, and is associated with the unique ID number beforehand. The database may be stored in the flash ROM 212 or a storage unit of a server installed on the LAN 104 via the network I/F 204. The information including the identification number, the e-mail address, and the favorite setting for each operation of the user can be stored in the contactless card while using the card I/F 350 in the reader/writer mode in which the information of the contactless card can be read and written. An NFC tag 360 has a storage unit in which various data are written by the CPU 201. The data is to be read by an NFC reader included in the mobile terminal 105. The various data include network information necessary to perform Wi-Fi® handover, such as an Internet Protocol (IP) address of the MFP 101 and a service set identifier (SSID) necessary for Wi-Fi Direct®. An audio control unit 370 controls a speaker 371 by receiving a signal from the CPU 201 via the operation unit I/F 340, so that audio guidance for a button control method and a beep for informing occurrence of an error are output for the user. The speaker 371 outputs sound based on a control signal. An internal signal bus 380 conveys an internal signal of the operation unit 203.

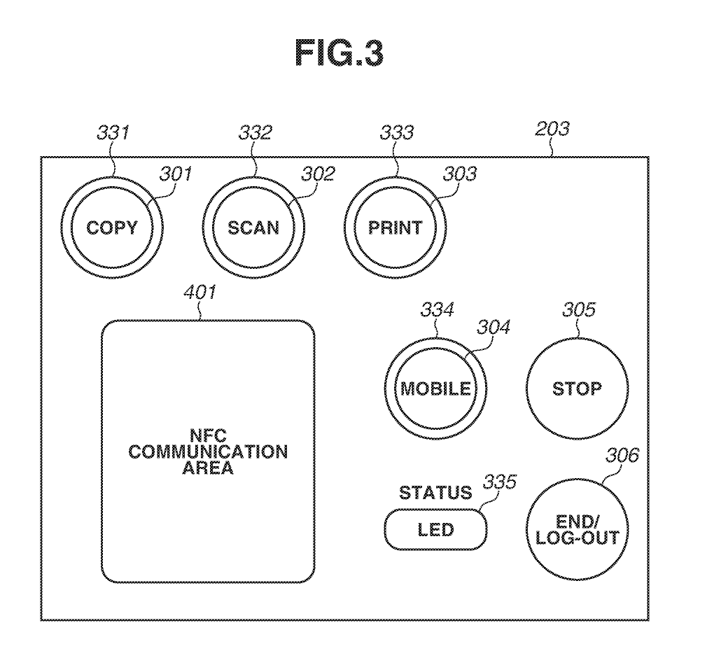

FIG. 3 is a diagram illustrating an example of a panel configuration of the operation unit 203. An NFC communication area 401 represents an area for communication with a contactless card and a mobile terminal. The antenna 351 and the NFC tag 360 are arranged behind the NFC communication area 401. If a contactless card is held close to the NFC tag 360 by the user, the contactless card and the card I/F 350 perform communication via the antenna 351, so that the information of the contactless card can be read and written. If a mobile terminal is held close to the NFC tag 360 by the user, the mobile terminal can read the network information written in the NFC tag 360. The copy button 301, the scan button 302, and the print button 303 are each used by the user to provide an instruction for performing a job (e.g., copy, scan, and print). The mobile button 304 enables the user to provide an instruction for notifying the user of the network information. The way of notifying the user of the network information includes displaying the network information on a display of the mobile terminal or the MFP 101 printing out the network information. The stop button 305 enables the user to provide an instruction for stopping a job input into the MFP 101. The end/log-out button 306 enables the user to provide an instruction for logging out of the MFP 101. The copy LED 331, the scan LED 332, and the print LED 333 are each provided to indicate whether the corresponding job (copy, scan, and print) is in an executable state. These LEDs are each turned on when the respective job is in the executable state. The mobile LED 334 prompts connection of the mobile terminal to the MFP 101. The status LED 335 notifies the user of a status of the entire MFP 101, and the status is provided using color. For example, the status LED 335 notifies the user of a normal state by turning green and an abnormal state by turning red. The NFC communication area 401 is an example of a wireless communication area.

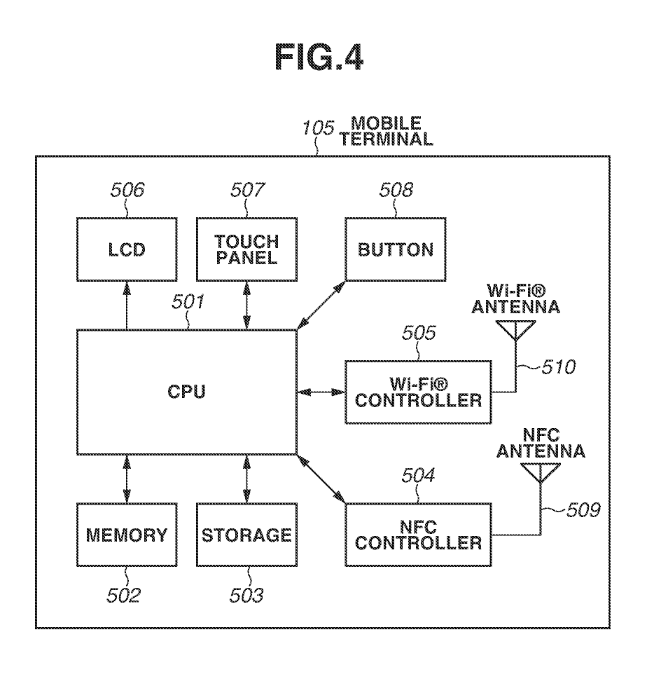

Next, FIG. 4 is a block diagram illustrating an example of a hardware configuration of the mobile terminal 105.

A CPU 501 controls components of the mobile terminal 105. A memory 502 is a temporary storage area used by the CPU 501. A storage 503 is a nonvolatile memory that holds a program and data. An NFC controller 504 can communicate with another NFC device via an NFC antenna 509 under control of the CPU 501. A Wi-Fi® controller 505 can communicate with another Wi-Fi® device via a Wi-Fi® antenna 510 under the control of the CPU 501. An LCD 506 receives screen data generated by the CPU 501 and displays the received screen data for the user. A touch panel 507 is transparent and is disposed on the front side of the LCD 506. If the user touches a part of an image such as a button displayed on an LCD screen, coordinates of the touched part is transmitted to the CPU 501. A button 508 is used as a button such as a power button used to power on/off or a home button used to return to a home screen.

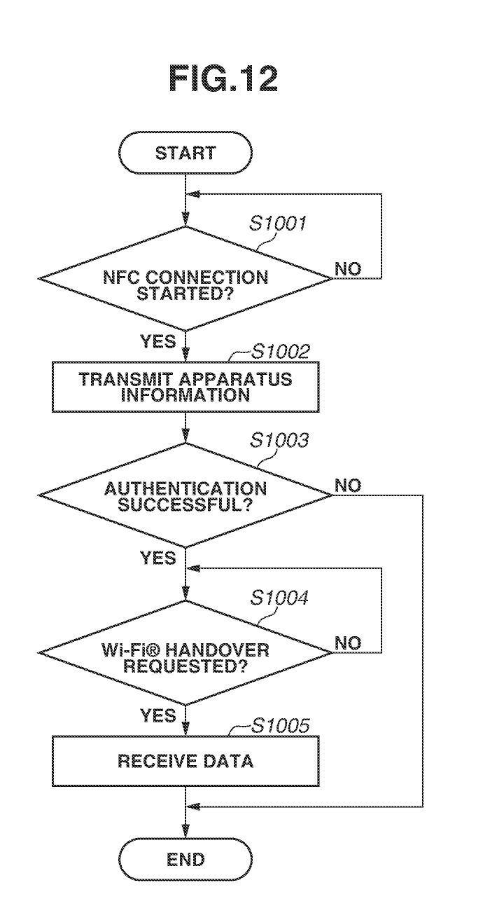

The CPU 501 performs processing based on the program stored in the storage 503 so that a function of the mobile terminal 105 and processing of a flowchart in FIG. 12 to be described below are implemented.

Basic information processing according to the first exemplary embodiment will be described with reference to FIGS. 5A and 5B.

In step S601, when the MFP 101 is activated, the CPU 201 determines whether mobile connection is established. If the mobile connection is not established (NO in step S601), the operation proceeds to step S602. If the mobile connection is established (YES in step S601), the operation proceeds to step S618.

In step S602, the CPU 201 is in a waiting state where communication with a contactless card is possible. Here, while the CPU 201 is in the state where the communication with a contactless card is possible, the CPU 201 can notify a user that a contactless card can be read by blinking the NFC communication area 401. If the user holds a card close to the NFC communication area 401, i.e., if the card is detected (YES in step S602), the operation proceeds to step S603. If no card is detected for a predetermined time (NO in step S602), the operation returns to step S601.

In step S603, the CPU 201 reads a unique ID from the contactless card. The CPU 201 performs user authentication by identifying whether a user corresponding to the unique ID is registered in the database of the HDD 208. Then, the operation proceeds to step S604.

In step S604, the CPU 201 determines whether the user authentication is successful. If the user authentication is successful (YES in step S604), a log-in state where the MFP 101 can be used begins, and the operation proceeds to step S605. If the user authentication fails (NO in step S604), the operation returns to step S601. The CPU 201 may notify the user of the success or failure of the authentication by lighting up the NFC communication area 401 in green or red using an LED.

In step S605, the CPU 201 acquires a job and setting information of the authenticated user. Here, as the setting information, examples of the default setting values are listed as table default setting values. An administrator or a user having editing authority can set the default setting values. Setting values for each of copy, scan, and fax jobs are determined as the table default setting values, and each of the jobs is executed using these default setting values. User setting values can also be set for each of the users as table user setting values separate from the default setting values.

TABLE 1
Table Default Setting Values

| | Color/black & | | Paper | | One-sided/ | | Number |
|---|---|---|---|---|---|---|---|
| Operation | white | Scaling | size | Finishing | two-sided | Resolution | of copies |
| Copy | Black & white | 100% | Auto | Sort | Two-sided | 300 dpi | 1 |
| Scan | Auto | 100% | Auto | — | One-sided | 200 dpi | — |
| Fax | — | 100% | Auto | — | One-sided | 200 dpi | — |

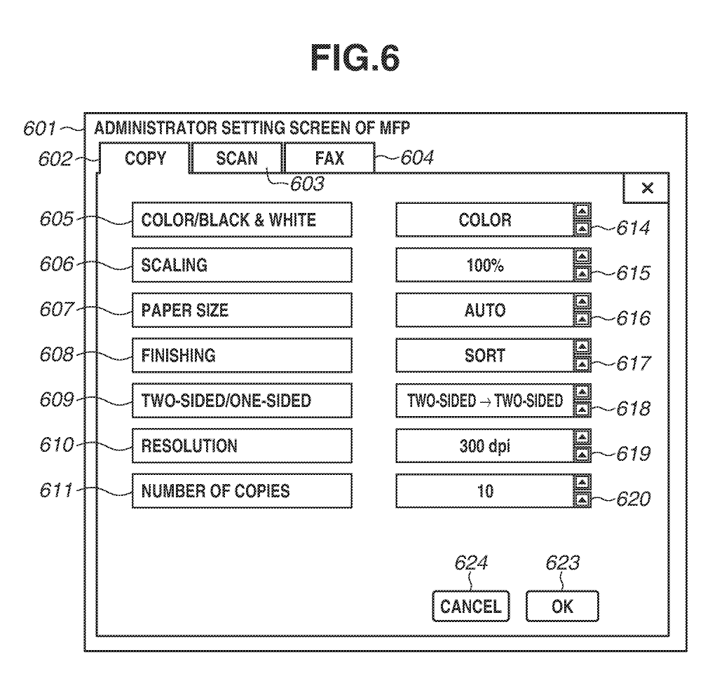

FIG. 6 illustrates examples of default values and an example of an administrator setting screen in the PC 102. Setting in the administrator setting screen can be performed in a browser format such as the Internet Explorer. A default setting display screen 601 is a screen on which administrator authentication and a default setting can be performed on a browser. Displayed setting values in this process are the table default setting values. The user can switch between setting screens for the respective jobs by selecting any of tabs 602 to 604. The screen displayed in FIG. 6 is a setting screen for copy. Items 605 to 611 represent items that can be set for a copy job. For example, the item 605 represents a setting item for color or black and white. Setting values 614 to 620 each represent a settable value for the corresponding item. For example, the setting value 614 represents a setting value for color or black and white, and indicates that the color is selected. If a cancel button 624 is selected, a change is canceled.

If an OK button 623 is selected, the changed setting becomes a default setting that is common to all users. The setting changed on the default setting display screen 601 is stored into the flash ROM 212 of the MFP 101 via the LAN 104.

The table default setting values in Table 1 each represent an example of the setting changed in the default setting display screen 601.

Each of the table user setting values in Table 2 can also be changed on a screen similar to the screen illustrated in FIG. 6, and the changed setting is saved into the flash ROM 212 of the MFP 101 via the LAN 104.

If a job can be executed based on the acquired information, the CPU 201 blinks or turns on the LED corresponding to the job. If the status of the MFP 101 is the normal state, copy and scan can be executed, and therefore, the CPU 201 turns on the copy LED 331 and the scan LED 332. If the user has input a reservation print job beforehand, the CPU 201 turns on the print LED 333 because the print job can be executed. In the reservation print, the user can transmit a print job to the MFP 101 beforehand from an apparatus such as the PC 102 via the network I/F 204, and obtain a printed sheet by logging into the MFP 101 in the above-described manner, so that the printed sheet is less likely to be seen by others. For a print job other than the reservation print job, printing is performed without waiting for button selection. In a state where a job cannot be executed, such as in a case where user-by-user restriction is set on use of a job or where a print job is not input, the copy LED 331, the scan LED 332, and the print LED 333 corresponding to the jobs remain turned off.

In step S606, the CPU 201 determines whether selection of the copy button 301 by the user while the copy LED 331 is on is detected. If the selection of the copy button 301 is detected (YES in step S606), the operation proceeds to step S607. If the selection of the copy button 301 is not detected (NO in step S606), the operation proceeds to step S608.

In step S607, the CPU 201 performs copy processing. The details of the copy processing will be described below. Upon completion of the copy processing, the operation proceeds to step S605.

In step S608, the CPU 201 determines whether selection of the scan button 302 by the user while the scan LED 332 is on is detected. If the selection of the scan button 302 is detected (YES in step S608), the operation proceeds to step S609. If the selection of the copy button 301 is not detected (NO in step S608), the operation proceeds to step S610.

In step S609, the CPU 201 performs scan processing. The details of the scan processing will be described below. Upon completion of the scan processing, the operation proceeds to step S605.

In step S610, the CPU 201 determines whether selection of the print button 303 by the user while the print LED 333 is on is detected. If the selection of the print button 303 is detected (YES in step S610), the operation proceeds to step S611. If the selection of the print button 303 is not detected (NO in step S610), the operation proceeds to step S612.

In step S611, the CPU 201 performs print processing. The print processing is the reservation print. Upon completion of the print processing, the operation proceeds to step S605.

In step S612, the CPU 201 determines whether selection of the mobile button 304 by the user while the mobile LED 334 is on is detected. If the selection of the mobile button 304 is detected (YES in step S612), the operation proceeds to step S613. If the selection of the mobile button 304 is not detected (NO in step S612), the operation proceeds to step S614.

In step S613, the CPU 201 notifies the user of the network information. The notification method is as described above. Upon completion of this processing, the operation proceeds to step S605.

In step S614, the CPU 201 determines whether selection of the stop button 305 by the user is detected. If the selection of the stop button 305 is detected (YES in step S614), the operation proceeds to step S615. If the selection of the stop button 305 is not detected (NO in step S614), the operation proceeds to step S616.

In step S615, the CPU 201 performs stop processing. When stopping of the currently performed processing is completed, the operation proceeds to step S605.

In step S616, the CPU 201 determines whether selection of the end/log-out button 306 by the user is detected. If the selection of the end/log-out button 306 is detected (YES in step S616), the operation proceeds to step S617. If the selection of the end/log-out button 306 is not detected (NO in step S616), the operation proceeds to step S605.

In step S617, the CPU 201 logs out of the user authentication state, and the operation proceeds to step S601.

In step S618, the CPU 201 performs processing based on a mobile operation. Upon completion of this processing, the operation proceeds to step S601. Details of processing to be performed in step S618 will be described below.

In the processing of the flowchart, the CPU 201 does not perform any processing even if a button is selected while the copy LED 331, the scan LED 332, the print LED 333, and the mobile LED 334 remain turned off.

Details of each of job processing described in FIGS. 5A and 5B will be described below.

### (Detailed Description of Copy Processing)

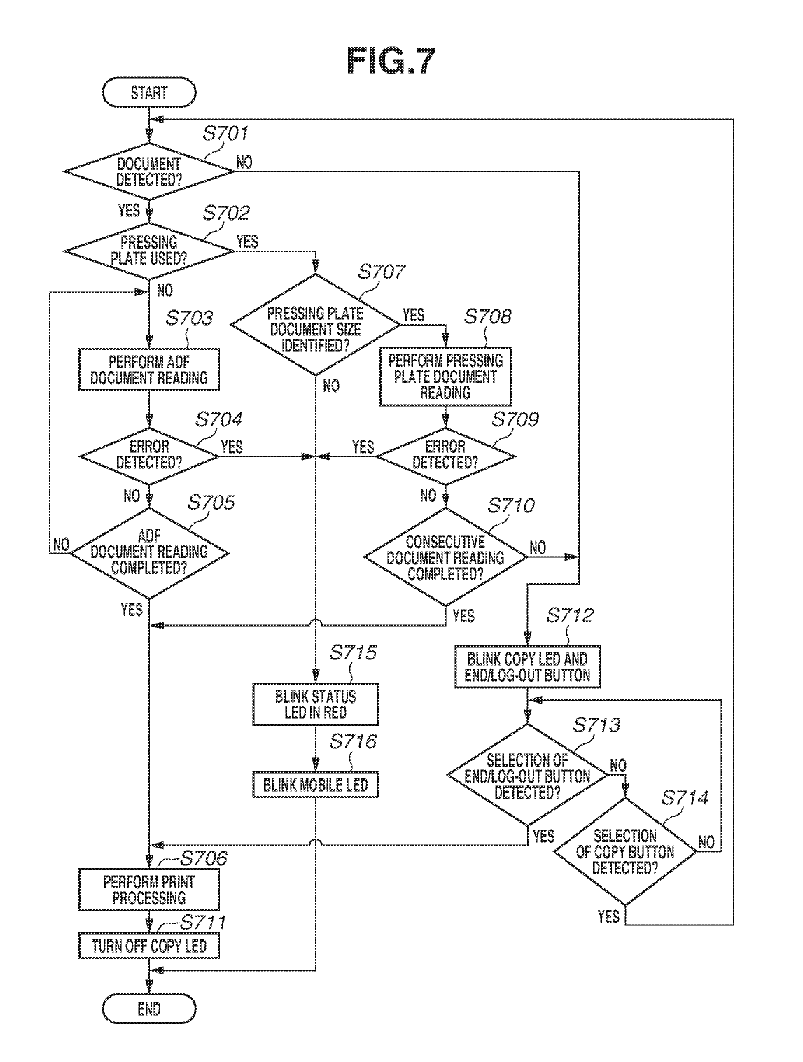

The copy processing in step S607 will be described with reference to FIG. 7.

In step S701, the CPU 201 determines whether placement of a document on a pressing plate or in an automatic document feeder (ADF) is detected based on a signal from a paper detection sensor of the scanner unit 206. If the placement of the document is detected (YES in step S701), the operation proceeds to step S702. If the placement of the document is not detected (NO in step S701), the operation proceeds to step S712.

In step S702, the CPU 201 determines whether presence of a document on the pressing plate is detected. If the document is in the ADF, not on the pressing plate (NO in step S702), the operation proceeds to step S703. If the document is on the pressing plate (YES in step S702), the operation proceeds to step S707.

In step S703, the CPU 201 reads the document from the ADF using the scanner unit 206, and stores image data obtained by the reading into the DRAM 202. Here, the CPU 201 determines whether it is necessary to read the document based on the copy setting information acquired in step S605 when the copy button 301 is selected. For example, in a case where two-sided reading is set, the CPU 201 selects a sheet conveyance path necessary for the two-sided reading, and performs the scan processing on both sides. In a case where a reading resolution or color/monochrome document reading is set, the CPU 201 performs processing based on the setting.

In step S704, the CPU 201 determines whether an error has occurred in the copy processing. For example, in a case where a paper jam occurs during scanning using the ADF or a paper jam occurs during printing, the CPU 201 detects occurrence of an error by receiving an error interrupt from a sensor provided inside the MFP 101. If there is no occurrence of an error (NO in step S704), the operation proceeds to step S705. If there is occurrence of an error (YES in step S704), the operation proceeds to step S715.

In step S705, the CPU 201 determines whether reading of all documents using the ADF is completed. If reading of all documents using the ADF is completed (YES in step S705), the operation proceeds to step S706. If any document remains to be read (NO in step S705), the operation proceeds to step S703.

In step S706, the CPU 201 converts the image data read in step S703 or step S708 (described below) into image data using the image processing unit 211 based on the setting values stored beforehand in the flash ROM 212, and prints the image data on a sheet surface using the printer unit 205. Then, the operation proceeds to step S711. In the processing of this flowchart, printing is performed after the document reading processing is completed. However, printing on a sheet surface may be performed at the time when output to a sheet surface becomes possible by performing image processing while a plurality of pages is being read.

In step S707, the CPU 201 determines whether the document size of the document on the pressing plate can be identified based on a signal from a paper size sensor of the scanner unit 206. If the document size can be identified (YES in step S707), the operation proceeds to step S708. If the document size cannot be identified (NO in step S707), the operation proceeds to step S715.

In step S708, the CPU 201 causes the scanner unit 206 to read the document on the pressing plate and stores image data obtained by the reading into the DRAM 202.

In step S709, the CPU 201 determines whether an error has occurred in the copy processing. For example, in a case where a paper jam occurs or paper runs out during printing, the CPU 201 detects occurrence of an error by receiving an error interrupt from a sensor provided inside the MFP 101. If there is no occurrence of an error (NO in step S709), the operation proceeds to step S710. If there is occurrence of an error (YES in step S709), the operation proceeds to step S715.

In step S710, the CPU 201 determines whether consecutive document reading is completed. At this time, the CPU 201 determines whether it is necessary to read the next document based on the copy setting information acquired in step S605 when the copy button 301 is selected and a count value indicating the number of read pages of the document. For example, in a case where two-sided document reading and two-sided printing are set in the copy setting, the CPU 201 determines that a page counter value is 1 after a first page, which is a front side, is read and that it is necessary to read a second page, which is a back side. Then, the operation proceeds to step S712. After the second page is read, the CPU 201 determines that the page counter value is 2, i.e., the document reading is completed, and the operation proceeds to step S706. Similarly, in a case where one-sided document reading and one-sided two-page output are set, the operation proceeds to step S712 if the page counter is 1, and the operation proceeds to step S706 if the page counter value is 2.

In step S711, the CPU 201 turns off the copy LED 331, and the copy processing is completed.

In step S712, the CPU 201 blinks the copy LED 331 and the end/log-out button 306 in order to prompt the user to place the next document or to provide a command of completion of reading. Then, the operation proceeds to step S713. The CPU 201 may output audio guidance to inform the user of a meaning of the blinking. For example, the CPU 201 controls the audio control unit 370 to output an audio message saying that “Press the end/log-out button if the reading is completed. Press the copy button if the next document is to be read.” from the speaker 371.

In step S713, the CPU 201 determines whether selection of the end/log-out button 306 while the end/log-out button 306 is in the blinking state by the user is detected. If the selection of the end/log-out button 306 is detected (YES in step S713), the operation proceeds to step S706. If the selection of the end/log-out button 306 is not detected (NO in step S713), the operation proceeds to step S714.

In step S714, the CPU 201 determines whether selection of the copy button 301 by the user in the blinking state of the copy LED 331 is detected. If the selection of the copy button 301 is detected (YES in step S714), the operation proceeds to step S701. If the selection of the copy button 301 is not detected (NO in step S714), the operation proceeds to step S713.

In step S715, the CPU 201 blinks the status LED 335 in red in order to notify the user of the error. Then, the operation proceeds to step S716. The CPU 201 can output a beep or audio guidance to notify the user of the meaning of the blinking. For example, the CPU 201 controls the audio control unit 370 to output an audio message saying, “An error has occurred.” from the speaker 371.

In step S716, the CPU 201 blinks the mobile LED 334 to prompt the user to establish a mobile connection. The CPU 201 can output audio guidance to notify the user of the meaning of the blinking. For example, the CPU 201 controls the audio control unit 370 to output an audio message saying that “Connect the mobile device to check details of the error. Press the mobile button to output the mobile connection information.” from the speaker 371. Details of the processing in cooperation with the mobile terminal will be described below. The processing in step S716 is an example of display control processing for controlling display of the mobile button 304 on the operation unit 203 in order to bring the mobile terminal 105 close to the MFP 101 to perform wireless communication.

### (Detailed Description of Job Stop Processing)

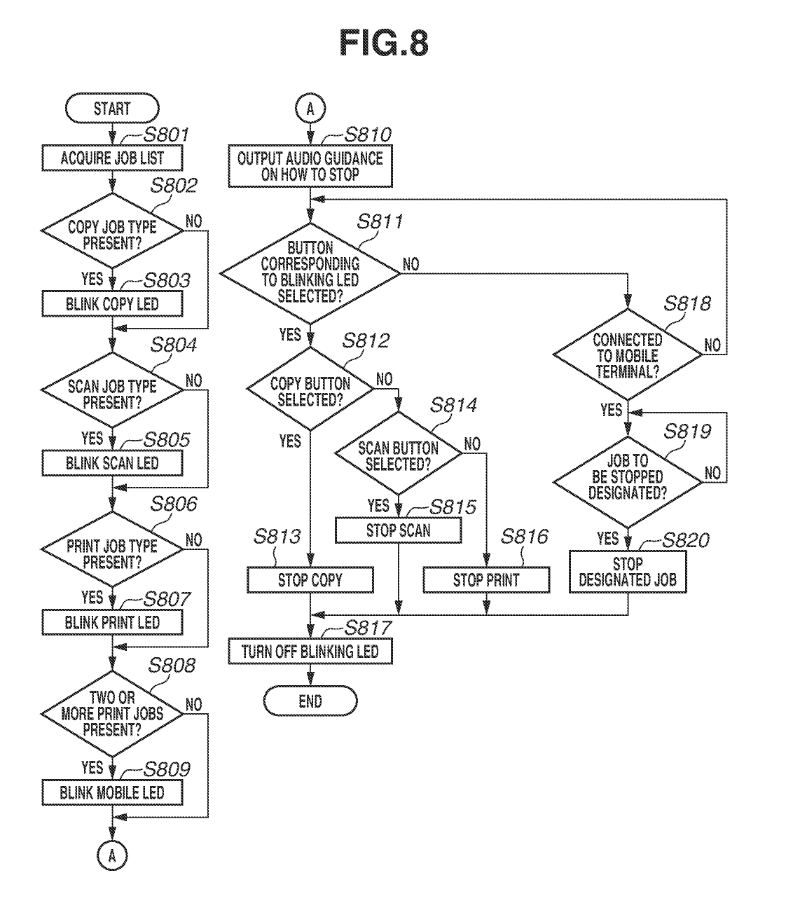

The stop processing in step S615 will be described with reference to FIG. 8.

In step S801, the CPU 201 acquires a job list of jobs input into the MFP 101.

In step S802, the CPU 201 determines whether a job whose job type is copy is present among the jobs input into the MFP 101. If the job whose job type is copy is present among the jobs input into the MFP 101 (YES in step S802), the operation proceeds to step S803. If the job whose job type is copy is not present (NO in step S802), the operation proceeds to step S804.

In step S803, the CPU 201 performs control for blinking the copy LED 331. In step S804, the CPU 201 determines whether a job whose job type is scan is present among the jobs input into the MFP 101. If the job whose job type is scan is present among the jobs input into the MFP 101 (YES in step S804), the operation proceeds to step S805. If the job whose job type is scan is not present (NO in step S804), the operation proceeds to step S806.

In step S805, the CPU 201 performs control for blinking the scan LED 332.

In step S806, the CPU 201 determines whether a job whose job type is print is present among the jobs input into the MFP 101. If the job whose job type is print is present among the jobs input into the MFP 101 (YES in step S806), the operation proceeds to step S807. If the job whose job type is print is not present (NO in step S806), the operation proceeds to step S808.

In step S807, the CPU 201 performs control for blinking the print LED 333.

In step S808, the CPU 201 determines whether there are two or more print jobs input into the MFP 101. If there are two or more print jobs input into the MFP 101 (YES in step S808), the operation proceeds to step S809. If there are not two or more print jobs input into the MFP 101 (NO in step S808), the operation proceeds to step S810.

In step S809, the CPU 201 performs control for blinking the mobile LED 334. Details of this processing will be described below.

In step S810, the CPU 201 outputs an audio guidance on how to stop the processing from the speaker 371 via the audio control unit 370. Here, contents of the guidance will be described. In a case where the copy LED 331 is blinking, the blinking indicates a state where a copy job is input into the MFP 101, and the copy button 301 can be selected. The CPU 201 provides guidance for prompting the user to select the copy button 301 if the user wants to stop the copy job. Similarly, in a case where the scan LED 332 is blinking, the blinking indicates a state where a scan job is input into the MFP 101, and the scan button 302 can be selected. The CPU 201 provides guidance for prompting the user to select the scan button 302 if the user wants to stop the scan job. Similarly, in a case where the print LED 333 is blinking, the blinking indicates a state where a print job is input into the MFP 101, and the print button 303 can be selected. The CPU 201 provides guidance for prompting the user to select the print button 303 if the user wants to stop the print job. In a case where the mobile LED 334 is blinking, two or more print jobs are input. If the user wants to select a desired job, it is necessary to select the job by connecting the mobile terminal 105 including the LCD. The CPU 201 provides guidance for notifying the user that there are two or more print jobs and mobile connection is necessary if the user wants to stop only a desired print job. The guidance is provided to notify the user of a role of each of the LEDs and the buttons and may be provided only when the user selects the stop button 305 for the first time.

In step S811, the CPU 201 determines whether the button 301, 302, or 303 corresponding to the LED 331, 332, or 333 in the blinking state is selected. The copy LED 331 corresponds to the copy button 301, the scan LED 332 corresponds to the scan button 302, and the print LED 333 corresponds to the print button 303. If the button corresponding to the LED in the blinking state is selected (YES in step S811), the operation proceeds to step S812. If the button corresponding to the LED in the blinking state is not selected (NO in step S811), the operation proceeds to step S818.

In step S812, the CPU 201 determines whether the copy button 301 is selected while the copy LED 331 is in the blinking state. If the CPU 201 determines that the copy button 301 is selected (YES in step S812), the operation proceeds to step S813. If the CPU 201 determines that the copy button 301 is not selected (NO in step S812), the operation proceeds to step S814.

In step S813, the CPU 201 stops all the copy jobs in the job list.

In step S814, the CPU 201 determines whether the scan button 302 is selected while the scan LED 332 is in the blinking state. If the CPU 201 determines that the scan button 302 is selected (YES in step S814), the operation proceeds to step S815. If the CPU 201 determines that the scan button 302 is not selected (NO in step S814), the operation proceeds to step S816. In step S815, the CPU 201 stops all the scan jobs in the job list.

In step S816, the CPU 201 stops all the print jobs in the job list.

In step S817, the CPU 201 performs control for turning off the LED (331, 332, or 333) in the blinking state.

In step S818, the CPU 201 determines whether connection to the mobile terminal 105 is established. If the CPU 201 determines that the connection to the mobile terminal 105 is established (YES in step S818), the operation proceeds to step S819. If the CPU 201 determines that the connection to the mobile terminal 105 is not established (NO in step S818), the operation proceeds to step S811.

In step S819, the CPU 201 determines whether a job to be stopped is designated by the mobile terminal 105. If the CPU 201 determines that the job to be stopped is designated by the mobile terminal 105 (YES in step S819), the operation proceeds to step S820. If the CPU 201 determines that the job to be stopped is not designated by the mobile terminal 105 (NO in step S819), the process in step S819 is repeated. When the connection to the mobile terminal 105 is established, the CPU 201 notifies the mobile terminal 105 of information indicating a job queue. The mobile terminal 105 displays the notified job queue on the LCD 506 of the mobile terminal 105 so that the user can select a job. If a job is selected, the mobile terminal 105 designates the selected job as a job to be stopped, and transmits the designated job to the MFP 101.

In step S820, the CPU 201 stops the designated job.

In the stop operation described above, a job type can be designated based on the status of an input job in the MFP 101 equipped with no LCD. In addition, in a case where there are two or more jobs of the same job type, the control for prompting the user to connect the mobile terminal 105 to the MFP 101 is performed by controlling the mobile LED 334 to blink. Thus, a job can be easily stopped even in an MFP equipped with no LCD.

### (Detailed Description of Scan Processing)

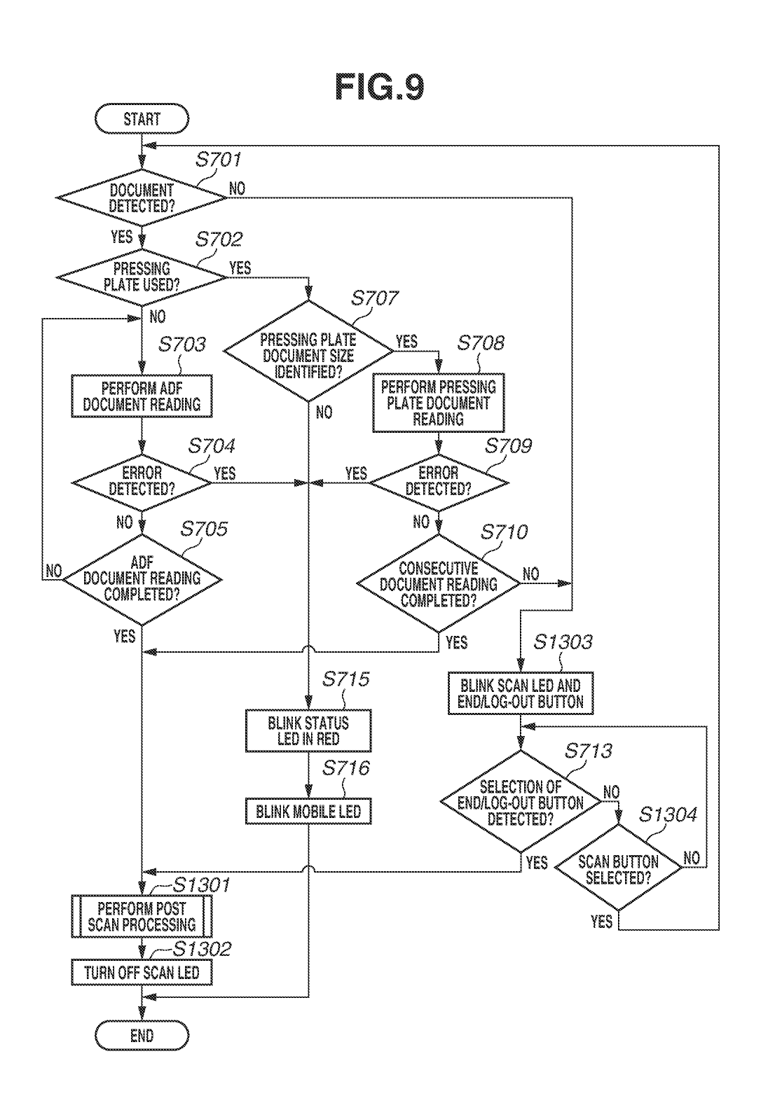

The scan processing in step S609 will be described with reference to FIG. 9.

In step S1301, the CPU 201 performs post scan processing on the image data read in step S703 or step S708. Then, the operation proceeds to step S1302. Details of the post scan processing will be described below. In the processing of the flowchart in FIG. 9, the post scan processing is performed after the document reading processing is performed. However, parallel processing may be performed at the time when the post scan processing becomes possible while a plurality of pages is being read.

In step S1302, the CPU 201 turns off the scan LED 332 and ends the scan processing.

In step S1303, the CPU 201 blinks the scan LED 332 and the end/log-out button 306 to prompt the user to place the next document or to provide a command for completing the reading. Then, the operation proceeds to step S713. The CPU 201 may output audio guidance to notify the user of the meaning of the blinking.

In step S1304, the CPU 201 determines whether the scan button 302 is selected by the user in the blinking state of the scan LED 332. If the CPU 201 determines that the scan button 302 is selected by the user in the blinking state of the scan LED 332 (YES in step S1304), the operation proceeds to step S701. If the CPU 201 determines that the scan button 302 is not selected (NO in step S1304), the operation proceeds to step S713.

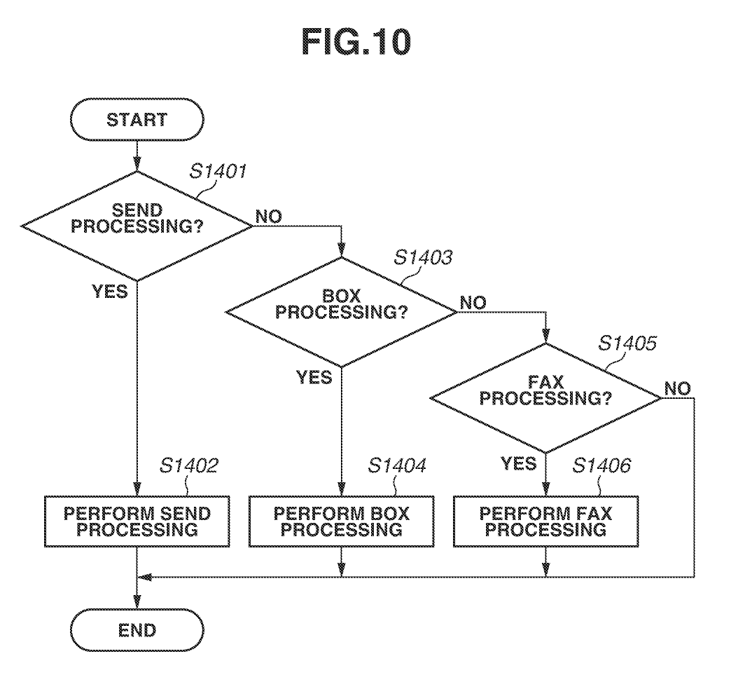

Next, the post scan processing will be described with reference to the flowchart in FIG. 10.

In step S1401, the CPU 201 determines whether the post scan processing is SEND processing based on the scan setting information acquired in step S605 when the scan button 302 is selected. If the post scan processing is the SEND processing (YES in step S1401), the operation proceeds to step S1402. If the post scan processing is not the SEND processing (NO in step S1401), the operation proceeds to step S1403.

In step S1402, the CPU 201 performs the SEND processing. In the present exemplary embodiment, a description is given of a scan setting set beforehand in which document data read in color is converted into a Portable Document Format (PDF) format and transmitted to the user himself/herself by e-mail. The CPU 201 converts the image data read in step S703 or step S708 into PDF data for SEND using the image processing unit 211 based on the setting values stored beforehand in the flash ROM 212. The CPU 201 creates e-mail data using an e-mail address based on the scan setting information acquired in step S605 as a destination, and transmits the created e-mail data via the network I/F 204.

In step S1403, the CPU 201 determines whether the post scan processing is BOX processing based on the scan setting information acquired in step S605 when the scan button 302 is selected. If the post scan processing is the BOX processing (YES in step S1403), the operation proceeds to step S1404. If the post scan processing is not the BOX processing (NO in step S1403), the operation proceeds to step S1405.

In step S1404, the CPU 201 performs the BOX processing. In the present exemplary embodiment, a description is given of a scan setting set beforehand in which document data read in color is converted into a Joint Photographic Experts Group (JPEG) format and stored in a folder in the HDD 208. The CPU 201 converts the image data read in step S703 or step S708 into JPEG data using the image processing unit 211 based on the setting values stored beforehand in the flash ROM 212. The CPU 201 stores the JPEG data into a folder in the HDD 208 based on the scan setting information acquired in step S605.

In step S1405, the CPU 201 determines whether the post scan processing is FAX processing based on the scan setting information acquired in step S605 when the scan button 302 is selected. If the post scan processing is the FAX processing (YES in step S1405), the operation proceeds to step S1406. If the post scan processing is not the FAX processing (NO in step S1405), the processing of the flowchart illustrated in FIG. 10 ends.

In step S1406, the CPU 201 perform the FAX processing. In the present exemplary embodiment, a description is given of a scan setting set beforehand in which read document data is transmitted by fax. The CPU 201 converts the image data read in step S703 or step S708 into FAX data using the image processing unit 211 based on the setting values stored beforehand in the flash ROM 212. The CPU 201 transmits the FAX data to a fax number based on the scan setting information acquired in step S605.

### (Detailed Description of Processing Based on Mobile Operation)

The processing based on the mobile operation related to step S716 and step S809 will be described.

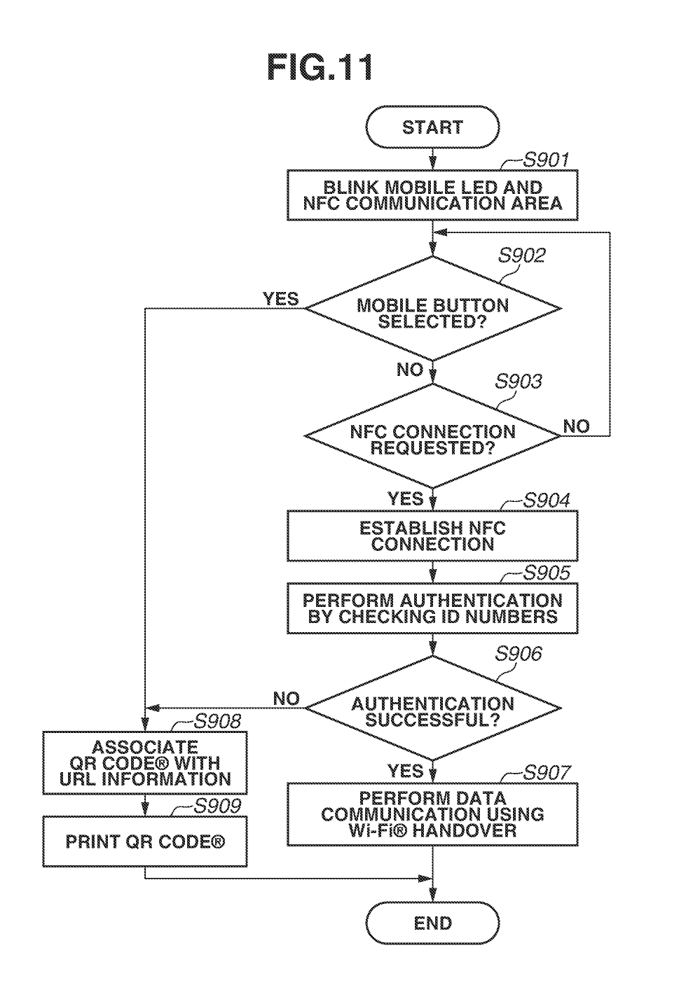

First, the processing of the MFP 101 will be described with reference to FIG. 11.

In step S901, the CPU 201 blinks the mobile LED 334 and the NFC communication area 401 to prompt the user to perform mobile connection/cooperation.

In step S902, the CPU 201 determines whether the mobile button 304 is selected by the user. If the mobile button 304 is selected (YES in step S902), the operation proceeds to step S908. If the mobile button 304 is not selected (NO in step S902), the operation proceeds to step S903.

In step S903, the CPU 201 determines whether the mobile terminal 105 is brought close to the NFC communication area 401 by the user and whether NFC connection is requested by the mobile terminal 105. If the NFC connection is requested (YES in step S903), the operation proceeds to step S904. If the NFC connection is not requested (NO in step S903), the operation proceeds to step S902.

In step S904, the CPU 201 establishes NFC communication and acquires an NFC unique ID number. Then, the operation proceeds to step S905.

In step S905, the CPU 201 performs authentication by checking whether the NFC unique ID number of the mobile terminal 105 matches a registration unique ID number stored in the HDD 208. Then, the operation proceeds to step S906.

In step S906, the CPU 201 determines whether the authentication is successful. If the authentication in step S905 is successful (YES in step S906), the operation proceeds to step S907. If the authentication in step S905 is not successful (NO in step S906), the operation proceeds to step S908.

In step S907, the CPU 201 performs Wi-Fi® handover by reading the network information in the NFC tag 360.

In step S908, in a case where the mobile terminal 105 is an apparatus not previously registered, the CPU 201 performs processing for connecting to the MFP 101. The CPU 201 generates a QR Code® associated with uniform resource locator (URL) information of the MFP 101. Then, the operation proceeds to step S909.

In step S909, the CPU 201 prints the QR Code® associated with the URL information.

Next, the processing by the mobile terminal 105 will be described with reference to FIG. 12.

In step S1001, the CPU 501 determines whether the mobile terminal 105 is brought close to the NFC communication area 401 by the user and whether NFC connection is started. If the NFC connection is started (YES in step S1001), the operation proceeds to step S1002. If the NFC connection is not started (NO in step S1001), the process in step S1001 is repeated.

In step S1002, the CPU 501 transmits the NFC unique ID information of the mobile terminal 105 to the MFP 101. Then, the operation proceeds to step S1003.

In step S1003, the CPU 501 determines whether authentication is successful. More specifically, the CPU 501 performs the determination by receiving a notification indicating whether the authentication is successful from the MFP 101. If the authentication is successful (YES in step S1003), the operation proceeds to step S1004. If the authentication is not successful (NO in step S1003), the CPU 501 displays an authentication unsuccessful screen, and the processing of the flowchart illustrated in FIG. 12 ends.

In step S1004, the CPU 501 determines whether Wi-Fi® handover is requested by the MFP 101. If the Wi-Fi® handover is requested (YES in step S1004), the operation proceeds to step S1005. If the Wi-Fi® handover is not requested (NO in step S1004), the process in step S1004 is repeated.

In step S1005, the CPU 501 receives the URL information transmitted from the MFP 101. The CPU 501 thereby acquires status information such as information about a job currently being executed by the MFP 101 and information about presence/absence of an error. Then, the CPU 501 displays the acquired status information on the LCD 506 of the mobile terminal 105.

### (Detailed Description of Display Screen Example of Mobile Terminal)

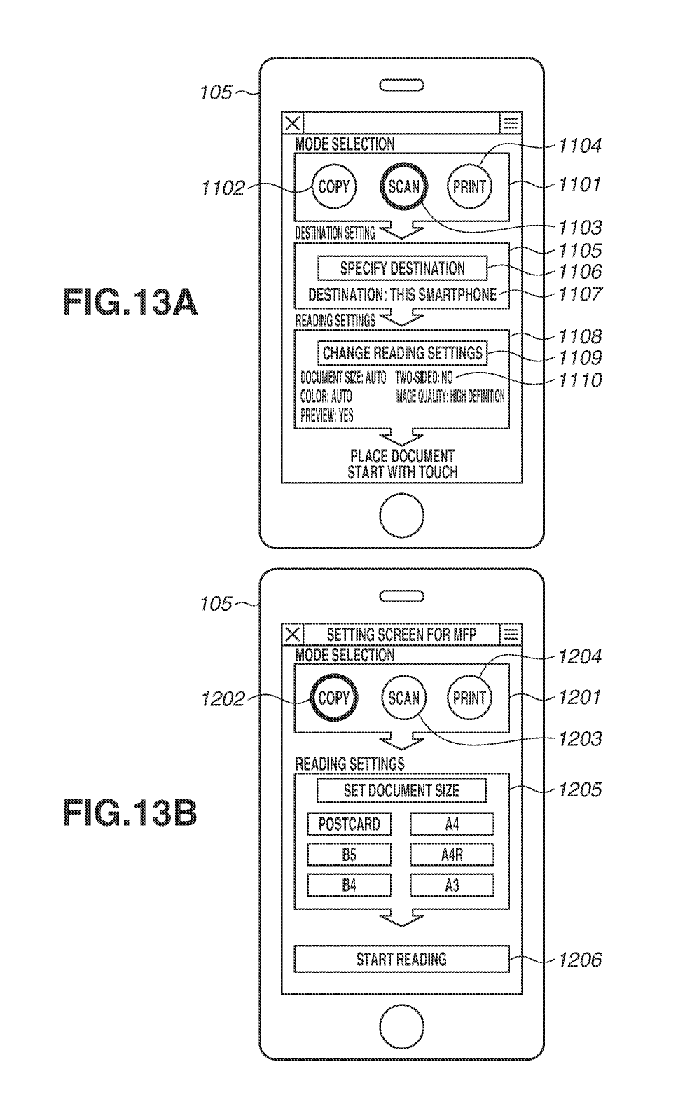

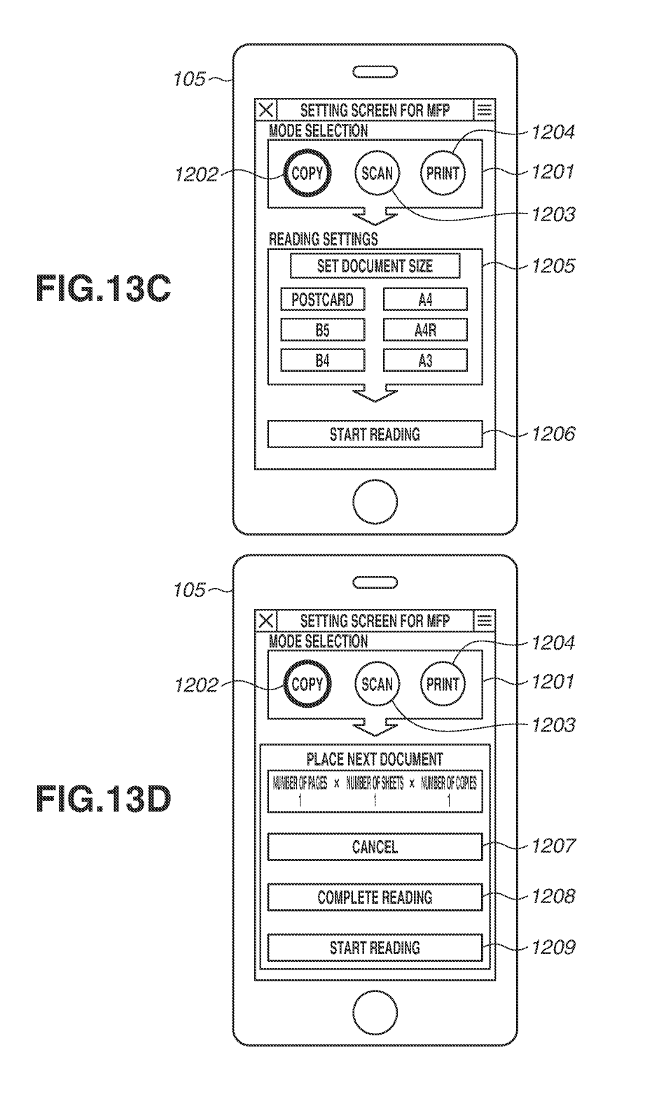

FIG. 13A is a default screen example of an application that starts up when the user operates the MFP 101 in a case where no job is executed in the MFP 101 after the Wi-Fi® handover of the mobile terminal 105 is established.

An area 1101 is a mode selection area. In the area 1 101, one of a copy button 1102, a scan button 1103, and a print button 1104 is enabled.

An area 1105 is a destination setting area. For a scan job, the user specifies, in the area 1105, a transmission destination (address) for image data obtained by a scan. The user can select between the mobile terminal 105 and an e-mail that are available as options by tapping a destination specifying button 1106. The selected destination is displayed in a destination area 1107.

An area 1108 is a reading settings area. The user can designate a document size, presence/absence of a two-sided scan, color/monochrome selection, image quality selection, and presence/absence of preview by tapping a button 1109 for changing reading settings. The set contents are displayed in a setting information display field 1100.

Details of the copy processing and the print processing other than the scan processing are similar to the above-described details, and will not be described.

Next, a method for performing processing using the mobile terminal 105 in a case where the size of the document on the pressing plate cannot be identified in steps S707 to S716 will be described.

In step S716, when the mobile LED 334 blinks, connection from the mobile terminal 105 to the MFP 101 is made. The connection is similar to the connection in the processes up to the successful Wi-Fi® handover of the processing described in the “Detailed Description of Processing Based on Mobile Operation”, and will not be described.

If the connection between the MFP 101 and the mobile terminal 105 is successful, the CPU 501 displays a screen illustrated in FIG. 13B on the LCD 506. An area 1201, a copy button 1202, a scan button 1203, and a print button 1204 are similar to the area 1101, the copy button 1102, the scan button 1103, and the print button 1104, respectively. However, in FIG. 13B, the copy button 1202 is in a selected state because the copy processing is being performed. The user sets a document size in an area 1205 surrounded by a black line in FIG. 13B. For example, if the user selects A3 in the area 1205 of this selection screen, the CPU 501 changes the screen to a screen in FIG. 13C. After the user sets the document size, a reading start button 1206 can be selected. If the reading start button 1206 is selected, the mobile terminal 105 notifies the MFP 101 that A3 is selected as the document size. The CPU 201 of the MFP 101 sets A3 as the document size and starts the copy processing. When the first page of the document is read, the screen of the mobile terminal 105 changes to a screen illustrated in FIG. 13D. In a case where the user wants to stop the copy processing, the user selects a cancel button 1207. This cancels the job processing. Upon receiving a notification of cancellation completion from the MFP 101, the CPU 501 returns the screen of the mobile terminal 105 to the default screen illustrated in FIG. 13A. In a case where the user wants to complete reading and perform the print processing, the user selects a reading completion button 1208. This causes execution of the print processing. Upon receiving a notification of completion of the copy processing from the MFP 101, the CPU 501 returns the screen of the mobile terminal 105 to the default screen illustrated in FIG. 13A. If the user wants to start the reading, the user selects a reading start button 1209. This causes execution of the document reading processing. Here, in a case where two-sided reading is set for the copy processing and the reading processing of the front side has been performed, the CPU 501 displays the screen illustrated in FIG. 13D again as the screen of the mobile terminal 105 upon receiving a notification of completion of the reading processing from the MFP 101. In a mode for allocating a plurality of pages to one page, similar operation is performed up to completion of reading of the plurality of pages. For example, in a case where four pages of a document are allocated to one page, the screen illustrated in FIG. 13D appears upon completion of the reading of first to three pages of the document. In a case where one-sided is set for the copy processing, the MFP 101 performs the reading processing and the print processing at the same time to complete the copy processing. Upon receiving a notification of completion of the copy processing from the MFP 101, the CPU 501 returns the screen of the mobile terminal 105 to the default screen illustrated in FIG. 13A.

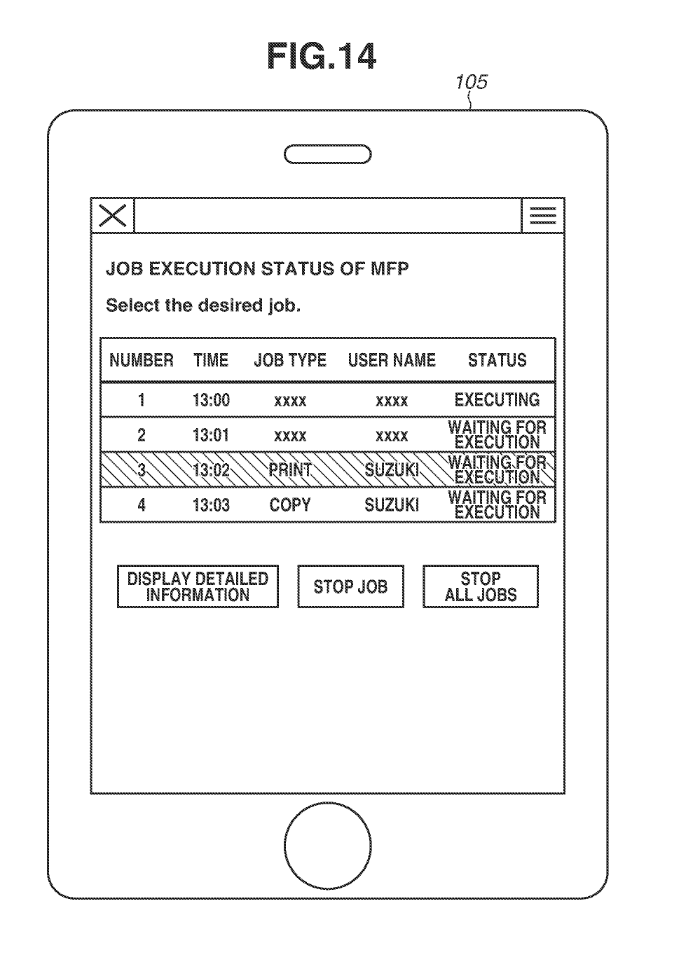

FIG. 14 is a diagram illustrating an example of a screen of the LCD 506 when the stop processing is performed from the mobile terminal 105. In the present exemplary embodiment, a case where a log-in user is Suzuki is used as an example, and a job execution status limited to the log-in user is illustrated. The user can perform an operation for selecting a desired job from a job list and stopping the selected job. However, display is controlled so that jobs of users different from the log-in user are not displayed and cannot be selected.

As described above, through the processing according to the present exemplary embodiment, even without an LCD that displays abundant information, it is possible to continue processing of an operation such as a document reading operation by changing a color of a button or blinking the button in a simple user interface (UI) of a main body of an apparatus.

It is also possible to set user setting values for each user as a table user setting values besides the default setting values.

TABLE 2
Table User Setting Value

| | | | Color/ | | | | | | | |
|---|---|---|---|---|---|---|---|---|---|---|
| User ID | User | | black & | | Paper | | One-sided/ | | Number | One |
| Number | name | Operation | white | Scaling | size | Finishing | two-sided | Resolution | of copies | job |
| 001 | ABC | Copy | Color | 100% | Auto | Sort | Two-sided | 300 dpi | 10 | Yes |
| 002 | DEF | Scan | Auto | 100% | Auto | — | One-sided | 600 dpi | — | No |

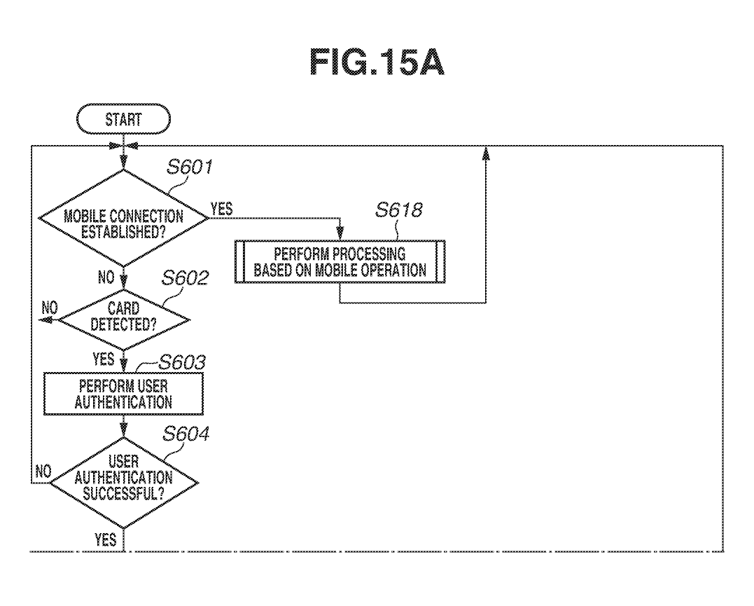

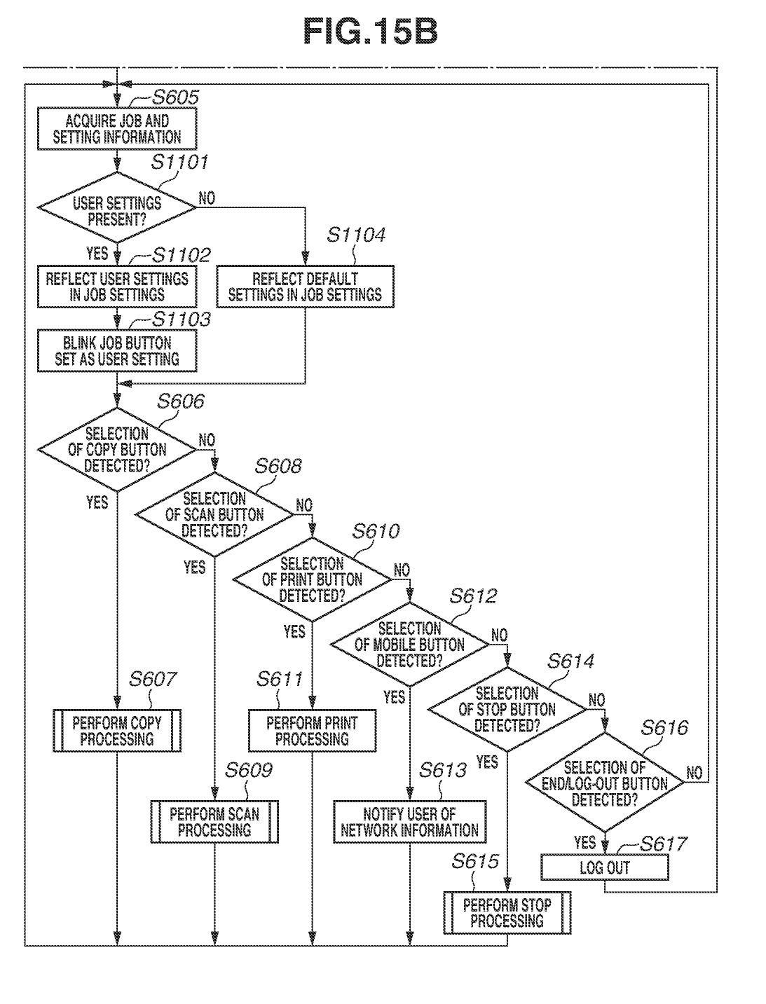

Basic information processing according to a second exemplary embodiment will be described with reference to FIGS. 15A and 15B. A part different from the flowchart in FIGS. 5A and 5B will be mainly described.

In step S1101, the CPU 201 checks whether a user setting for each user stored in the flash ROM 212 is present. If the user setting is present (YES in step S1101), the operation proceeds to step S1102. If the user setting is not present (NO in step S1101), the operation proceeds to step S1104.

In step S1102, the CPU 201 reflects the user setting for each user in a job setting. Then, the operation proceeds to step S1103.

In step S1103, the CPU 201 blinks, by controlling the LED control unit 320, the job LED set in the user setting performed in step S1102. For example, the CPU 201 blinks the copy LED 331 if a copy job is set as the user setting. Accordingly, the user can determine which job is set as the user setting.

In step S1104, because it is determined in step S1101 that the user setting is not present, the CPU 201 reflects the default setting set by the administrator in the job setting.

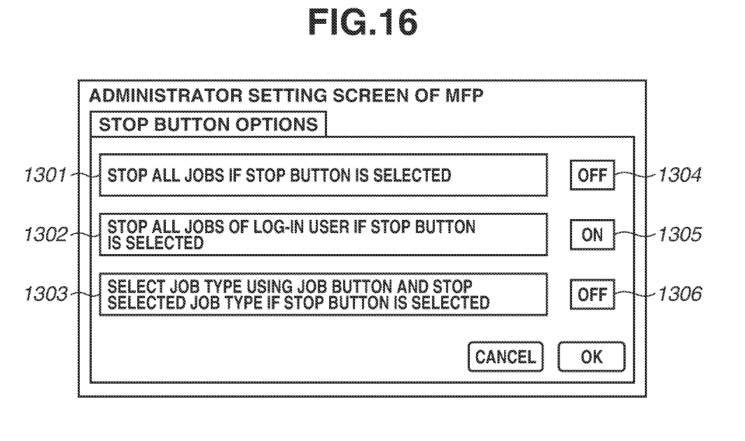

The user can operate an administrator setting screen such as a screen illustrated in FIG. 16 from an apparatus such as the PC 102 by remotely connecting to the MFP 101. A button 1301 is provided to stop all jobs if a stop button is selected. A button 1302 is provided to stop all jobs of a log-in user if the stop button is selected. A button 1303 is provided to select a job type using a job button and to stop the selected job type if the stop button is selected. The user can make selection by selecting ON/OFF of the buttons 1301 to 1303, i.e., by turning ON any one of ON/OFF buttons 1304 to 1306 only. The user can set the operation of the stop button on this administrator setting screen beforehand, whereby the user can use the stop button differently depending on the situation. In addition, the operation of the stop button can be set as desired for each user so as to increase user's convenience.

In the first exemplary embodiment, the processing for outputting the reservation print job by selecting the print button in the MFP 101 having the simple operation unit has been described.

As for a print job, there is known a print job outputting method in which security is enhanced in outputting a print job (hereinafter referred to as secure print). In the secure print, the security is enhanced by adding a password for a reservation print job beforehand to output the job.

In the conventional secure print using an MFP, a user designates the secure print using a printer driver at the time of inputting a print job. The user designates a print job and inputs a numerical string on a keyboard of a PC, for example, as a password for the designated print job. More specifically, the user designates the reservation print job in an operation unit of the MFP, and inputs the password using a numeric keypad included in the operation unit (hardware keys or software keys on a panel of the operation unit). If the input password matches the password for the designated job, the print job is output.

However, in a case where the secure print is performed on the MFP 101 neither equipped with an LCD panel nor hardware keys such as the numeric keypad, a numerical string cannot be used as a password for the secure print because the MFP 101 does not include the numeric keypad. Here, a method may be considered in which a password not formed of a numerical string is used and buttons provided on the MFP, not a numeric keypad, is used. However, since the password is not formed of numbers, it is difficult for a user to input the password using the printer driver. Moreover, because the number of the buttons provided to the MFP is small compared with that of a numeric keypad, combinations of the buttons for the password are few, and the level of security decreases.

Thus, processing for performing the secure print using the buttons included in the operation unit 203 of the MFP 101 will be described in a third exemplary embodiment.

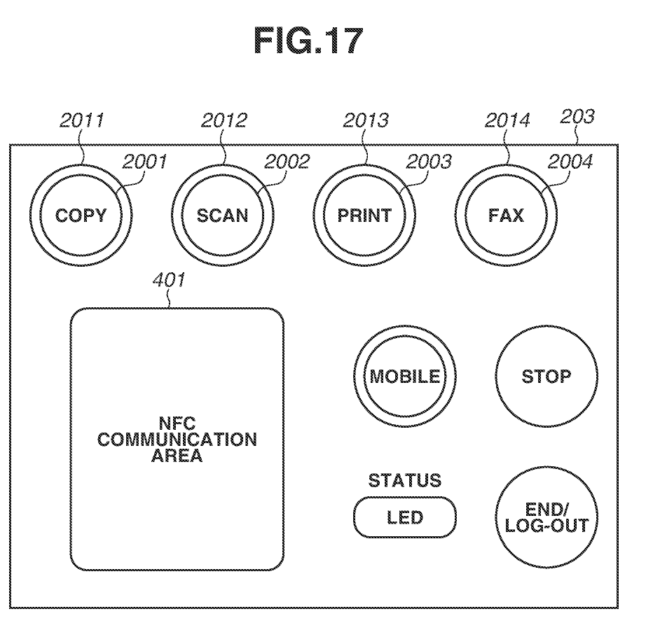

First, another configuration of the operation unit 203 that is included in the MFP 101 and added in the present exemplary embodiment will be described with reference to FIG. 17.

An operation unit 203 includes a button 2004 for fax execution in addition to a copy button 2001, a scan button 2002, and a print button 2003 to be used for job execution. The operation unit 203 also includes a light emitting unit 2014 corresponding to the button 2004 in addition to light emitting units 2011, 2012, and 2013 corresponding to the buttons 2001, 2002, and 2003, respectively. The process performed in step S1406 by scan button selection in the first exemplary embodiment is executed by fax button selection.

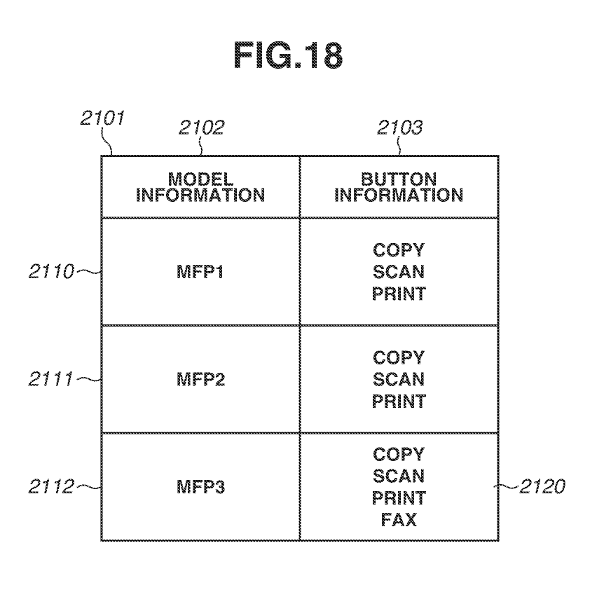

Next, button information indicating buttons to be used for password input in the secure print will be described with reference to FIG. 18. The button information illustrated in FIG. 18 is held for each model supported by a printer driver of the PC 102.

Button information 2101 in the present exemplary embodiment includes model information 2102 about three models 2110 to 2112, and button information 2103 about a button that is included in each of the models and is to be used for password input in the secure print. The button information about an MFP 1 (model 2110) and an MFP 2 (model 2111) indicates COPY, SCAN, and PRINT. The button information about an MFP 3 (model 2112) indicates COPY, SCAN, PRINT, and FAX. Accordingly, a password in the secure print is formed of three buttons in the MFP 1 (the model 2110) and the MFP 2 (model 2111), and formed of four buttons in the MFP 3 (model 2112).

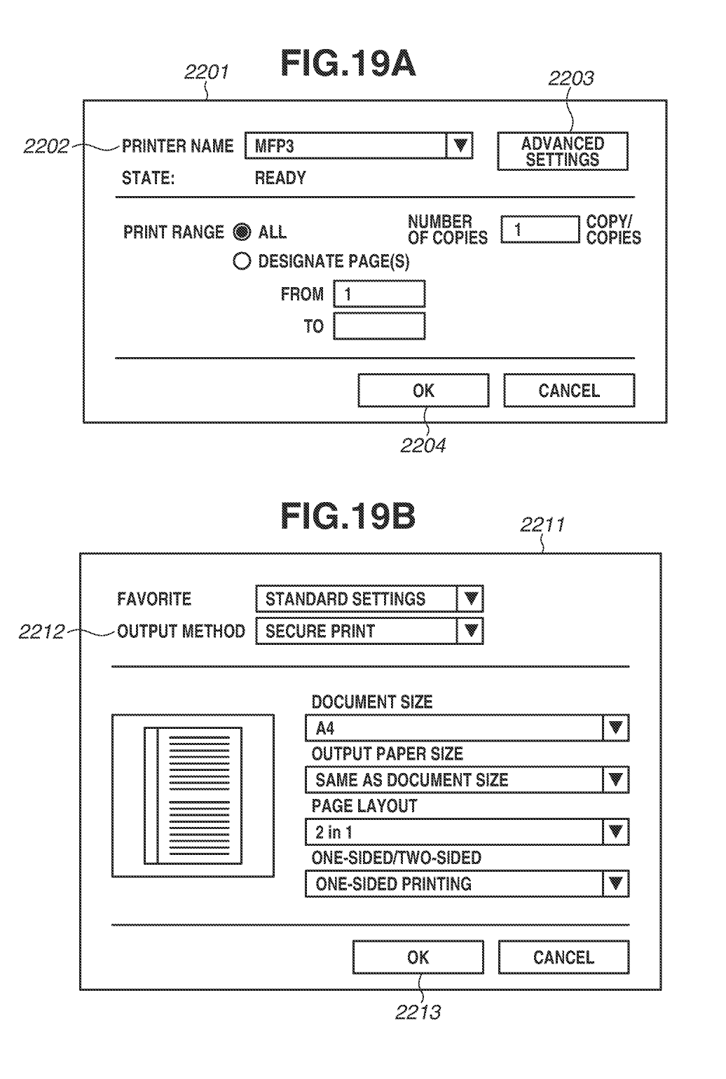

Next, processing to be performed by the printer driver when a secure print job is input into the MFP 101 from the PC 102 will be described with reference to FIGS. 19A, 19B, 20, and 21. The printer driver described in the present exemplary embodiment supports a plurality of models of the MFP 101 having the simple operation unit.

FIGS. 19A and 19B are diagrams each illustrating an example of an operation screen of the printer driver that is included in the PC 102 and provided for the MFP 101. A screen 2201 is a first print driver screen that is displayed on a display of the PC 102 when a user provides an instruction for printing text that is opened using an application from the PC 102. The screen 2201 includes a pull-down menu for designating a printer name 2202 used for output, buttons and input boxes used for designating other settings, and an advanced settings button 2203 used for opening an advanced setting screen. In the present exemplary embodiment, the MFP 101 is designated by the printer name “MFP 3”.

A screen 2211 is a screen used for designating more advanced print settings than the settings in the screen 2201 and that is opened by the user selecting the advanced settings button 2203 on the screen 2201. The screen 2211 includes a pull-down menu for designating an output method 2212. In the present exemplary embodiment, the user selects the secure print from the pull-down menu.

The user also designates other setting items on the screen 2211 and confirms the print settings by selecting an OK button 2213. Then, the screen returns to the screen 2201 in which the user confirms the settings in the printer driver by selecting an OK button 2204.

FIG. 20 is a flowchart illustrating processing to be performed when the secure print is designated in the printer driver. A CPU included in the PC 102 executes the processing of the flowchart in FIG. 20 after the user selects the OK button 2204 on the screen 2201 of the printer driver.

In step S1601, the CPU of the PC 102 determines whether the secure print is set as the output method 2212. If the secure print is set as the output method 2212 (YES in step S1601), the operation proceeds to step S1602. If the secure print is not set as the output method 2212 (NO in step S1601), the operation proceeds to step S1608.

In step S1602, the CPU of the PC 102 acquires operation button information of a printer designated for output based on the button information 2101 and the printer name 2202. In the present exemplary embodiment, “MFP 3” is designated as the printer name 2202 used for output, and the CPU of the PC 102 acquires “COPY, SCAN, PRINT and FAX” as button information 2120.

In step S1603, the CPU of the PC 102 displays a password input screen for setting a password in the secure print on the display of the PC 102 based on the operation button information of the printer used for output acquired in step S1602.

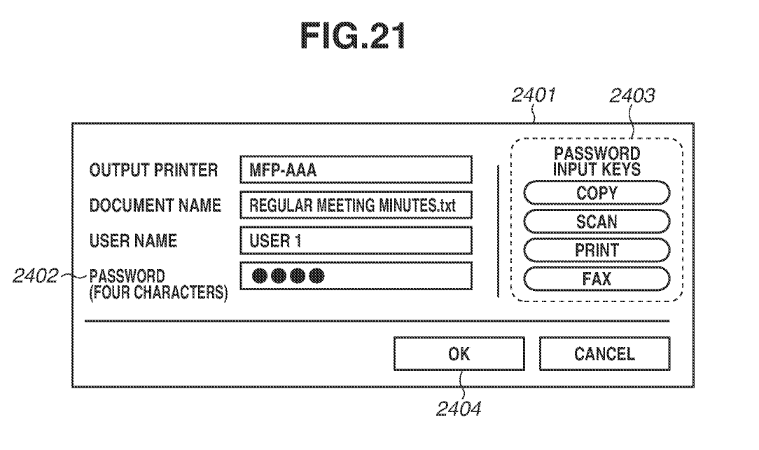

FIG. 21 is a diagram illustrating an example of the password input screen displayed in step S1603. A screen 2401 is provided for inputting various settings of a secure print job designated for print. The screen 2401 includes a text box 2402 for displaying a password, and buttons 2403 used for inputting the password. The buttons 2403 used for inputting the password is displayed based on the operation button information of the printer designated for output acquired in step S1602. The user inputs the password by selecting from the buttons. Black dots are displayed in the text box 2402 corresponding to a length of the input password. In the present exemplary embodiment, COPY, SCAN, PRINT, and FAX buttons are displayed on the screen 2401 as the buttons 2403 used for inputting the password based on the operation button information acquired in step S1602.

Referring back to the flowchart in FIG. 20, in step S1604, the CPU of the PC 102 determines whether selection of a setting confirmation button (OK button) 2404 on the screen 2401 displayed in step S1603 is detected (i.e., whether the input password is confirmed). In the present exemplary embodiment, the length of the password is a predetermined fixed length and is shared with the MFP 101 beforehand. If the selection of the setting confirmation button 2404 is detected (YES in step S1604), the operation proceeds to step S1605. If the selection of the setting confirmation button 2404 is not detected (NO in step S1604), the process of step S1604 is repeated.

In step S1605, the CPU of the PC 102 determines whether the number of inputs into the text box 2402 has the predetermined fixed length. If the CPU of the PC 102 determines that the number of inputs into the text box 2402 has the predetermined fixed length (YES in step S1605), the operation proceeds to step S1606. If the CPU of the PC 102 determines that the number of inputs into the text box 2402 does not have the predetermined fixed length (NO in step S1605), the operation proceeds step S1607. In the present exemplary embodiment, the length of the password is 4, and the input password is formed of PRINT, SCAN, SCAN, and FAX.

In step S1606, the CPU of the PC 102 sets the input password and the length of the password in the print job as information. Then, the CPU of the PC 102 transmits the print job to the printer having the printer name 2202 for output. The input password is formed of PRINT, SCAN, SCAN, and FAX as described above.

In step S1607, the CPU of the PC 102 displays a screen for prompting the user to re-input the password. The CPU of the PC 102 displays the screen 2401 in which the text box 2402 is cleared, and the operation proceeds to step S1604 to wait for a re-input of the password.

In step S1608, the CPU of the PC 102 performs processing based on another output method designated in the output method 2212.

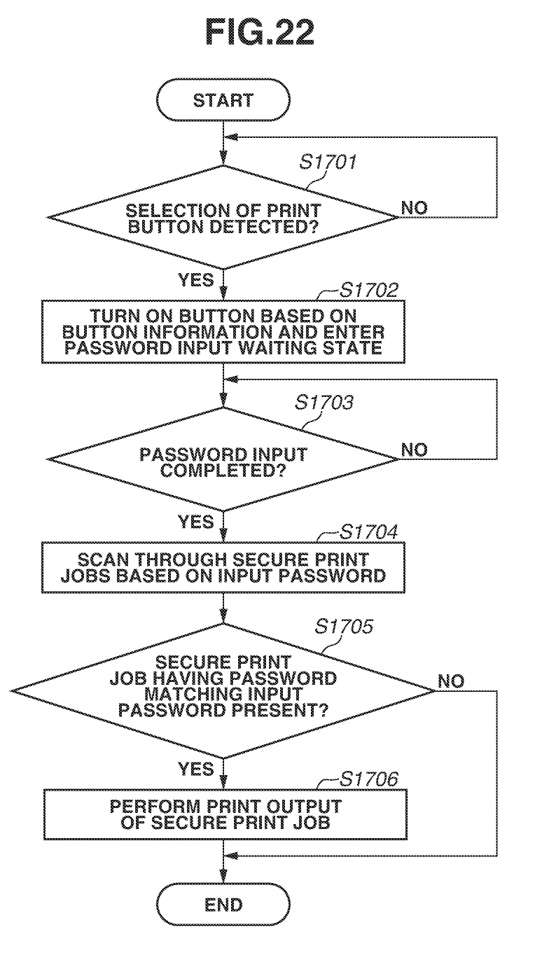

Next, processing for output of the secure print job received by the MFP 101 having the simple operation unit will be described with reference to FIG. 22. The processing illustrated in FIG. 22 is performed in a state where the secure print job transmitted from the PC 102 is received by the MFP 101 and user authentication is completed by the MFP 101.

In step S1701, the CPU 201 determines whether selection of the print button 2003 of the operation unit 203 is detected. If the selection of the print button 2003 of the operation unit 203 is detected (YES in step S1701), the operation proceeds to step S1702. If the selection of the print button 2003 of the operation unit 203 is not detected (NO in step S1701), the process of step S1701 is repeated.

In step S1702, based on button information indicating buttons to be used for password input, the CPU 201 turns on the buttons to be used for the password input. Here, the button information is similar to the button information 2120 corresponding to the MFP 3 (model 2112) included in the button information 2101 described above, and the CPU 201 acquires the information stored beforehand in the HDD 208 of the MFP 101. In the present exemplary embodiment, the CPU 201 uses the COPY, SCAN, PRINT, and FAX buttons for the password input based on the button information. The CPU 201 turns on the light emitting units 2011 to 2014 of the respective buttons and enters a state of awaiting input of the buttons (password input waiting state).

In step S1703, the CPU 201 is in the password input waiting state. The CPU 201 waits until the password having the predetermined length is input for the buttons based on the button information acquired in step S1702. The length of the password in the present exemplary embodiment is 4, and the CPU 201 determines that a password input is completed if the buttons are pressed four times in total. If the CPU 201 determines that the password input is completed (YES in step S1703), the operation proceeds to step S1704. If the CPU 201 determines that the password input is not completed (NO in step S1703), the process in step S1703 is repeated.

In step S1704, the CPU 201 scans through passwords associated with jobs reserved as secure print jobs based on the input password. In the present exemplary embodiment, because the log-in authentication is valid, the CPU 201 scans through reserved secure print jobs associated with an authenticated user.

In step S1705, the CPU 201 determines whether there is a secure print job having a password that matches the input password. If there is a secure print job having a password that matches the input password (YES in step S1705), the operation proceeds to step S1706. If there is no secure print job having a password that matches the input password (NO in step S1705), the operation skips step S1706. Then, the processing of the flowchart illustrated in FIG. 22 ends.

In step S1706, the CPU 201 performs print output of the reserved secure print job, and the processing of the flowchart illustrated in FIG. 22 ends.

As described above, even in the MFP 101 including the operation unit 203 not provided with an LCD panel and hardware keys such as a numeric keypad, the password for the secure print job can be set using the printer driver based on the buttons included in the operation unit 203. The password for the secure print job can be input only by operating the buttons included in the operation unit 203 of the MFP 101, so that the job output can be performed.

Contents of the descriptions of the present exemplary embodiment are not limited to the above.

In the present exemplary embodiment, the password for the secure print is described to be input by the user, but the password may also be automatically generated by the printer driver. In this case, the printer driver automatically generates a password different from the password for the secure print job reserved in the printer designated by the printer name 2202 to be used for output. The MFP 101 is described to have the log-in authentication function, but the secure print can also be performed only by operating the buttons of the operation unit 203 even if the MFP 101 is an MFP including a simple operation unit and not having a log-in authentication function. In this case, the printer driver performs automatic password generation processing instead of performing the password input processing performed in step S1603 to step S1607 in the printer driver. Accordingly, in a case where the secure print output is performed using the MFP 101 not having the log-in authentication function, output of a job of another user due to setting of a duplicate password can be avoided when password determination processing is performed on reserved secure print jobs of all users.

One or more functions of the above-described exemplary embodiments can be implemented by supplying a program to a system or an apparatus via a network or a storage medium, and causing one or more processors in a computer of the system or the apparatus to execute processing by reading out the program. The one or more functions can also be implemented by a circuit (e.g., an application-specific integrated circuit (ASIC)).

While exemplary embodiments are described above, these exemplary embodiments are not seen to be limiting.

For example, the processing of each of the exemplary embodiments described above is applicable to a system including a plurality of apparatuses.

A graphics processing unit (GPU) can be used in place of the CPU in the hardware configuration of the MFP 101.

According to the processing of each of the exemplary embodiments described above, information necessary for a user can be provided even in an image processing apparatus having only a simple UI.

### Other Embodiments

Embodiments can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-085615, filed Apr. 26, 2018, which is hereby incorporated by reference herein in its entirety.

What is claimed is:

1. An image processing apparatus comprising:
a wireless communication interface configured to wirelessly communicate with a mobile terminal;
an element configured to initiate wireless communication with the mobile terminal;
a light emitting element, associated with the element, configured to emit light; and
at least one controller configured to cause the light emitting element to emit light in response to occurrence of an event requiring communication with the mobile terminal.

2. The image processing apparatus according to claim 1, wherein the at least one controller causes the light emitting element to blink in response to the occurrence of the event.

3. The image processing apparatus according to claim 1, wherein the element is a button configured to receive a touch operation.

4. The image processing apparatus according to claim 1, wherein information about the event is transmitted to the mobile terminal based at least on proximity of the mobile terminal to the wireless communication interface after the occurrence of the event.

5. The image processing apparatus according to claim 1, wherein the event is related to a print job.

6. The image processing apparatus according to claim 1, wherein the event is related to an error condition.

7. The image processing apparatus according to claim 1, further comprising:
an additional element associated with a predetermined job type; and
an additional light emitting element, associated with the additional element, configured to emit light,
wherein the at least one controller causes the additional light emitting element to emit light in a case where the event is an event associated with the predetermined job type.

8. The image processing apparatus according to claim 1, further comprising:
an additional element associated with a status of the image processing apparatus; and
an additional light emitting element, associated with the additional element, configured to emit light,
wherein the at least one controller causes the additional light emitting element to emit light in a case where the event is an event associated with the status of the image processing apparatus.

9. The image processing apparatus according to claim 1, further comprising a wireless local area network interface,
wherein the wireless communication interface transmits, to the mobile terminal, information for performing communication with the mobile terminal via the wireless local area network interface in response to proximity of the mobile terminal to the image processing apparatus.

10. The image processing apparatus according to claim 9, wherein the information for performing the communication via the wireless local area network interface is network information.

11. The image processing apparatus according to claim 10, wherein the network information includes one or more of a service set identifier or an Internet Protocol address.

12. The image processing apparatus according to claim 1, wherein the at least one controller performs authentication processing based on identification information acquired from the mobile terminal via the wireless communication interface.

13. The image processing apparatus according to claim 1, wherein the wireless interface is a near field communication interface.

14. A control method for an image processing apparatus including a wireless communication interface configured to wirelessly communicate with a mobile terminal, an element configured to initiate wireless communication with the mobile terminal, and a light emitting element, associated with the element, configured to emit light, the control method comprising:
causing the light emitting element to emit light in response to occurrence of an event requiring communication with the mobile terminal.

15. The control method according to claim 14, wherein the light emitting element is caused to blink in response to the occurrence of the event.

16. The control method according to claim 14, wherein information about the event is transmitted to the mobile terminal based at least on proximity of the mobile terminal to the wireless communication interface after the occurrence of the event.

17. The control method according to claim 14, wherein the event is related to a print job.

18. The control method according to claim 14, wherein the event is related to an error condition.

19. The control method according to claim 14, wherein the control method further causes an additional light element associated with an additional element that is associated with a predetermined job type to emit light in a case where the event is an event associated with the predetermined job type.

20. A non-transitory computer-readable storage medium that stores a program for causing a computer to execute a control method for an image processing apparatus including a wireless communication interface configured to wirelessly communicate with a mobile terminal, an element configured to initiate wireless communication with the mobile terminal, and a light emitting element configured to emit light, the control method comprising:
causing the light emitting element to emit light in response to occurrence of an event requiring communication with the mobile terminal.
